(19) United States
(12) Patent Application Publication
(10) Pub. No.: US 2022/0155636 A1
(43) Pub. Date: May 19, 2022

(54) LIQUID CRYSTAL DISPLAY DEVICE

(71) Applicant: SHARP KABUSHIKI KAISHA, Sakai City (JP)

(72) Inventors: HIROYUKI HAKOI, Sakai City (JP); TAKAHIRO SASAKI, Sakai City (JP); TAKASHI SATOH, Sakai City (JP)

(21) Appl. No.: 17/522,321

(22) Filed: Nov. 9, 2021

Related U.S. Application Data
(60) Provisional application No. 63/115,330, filed on Nov. 18, 2020.

(51) Int. Cl. G02F 1/1335; G02F 1/13363; G02F 1/139

(52) U.S. Cl. CPC G02F 1/133555; G02F 1/133638; G02F 1/133531; G02F 2413/06; G02F 2203/09; G02F 2413/02; G02F 1/1393

(57) ABSTRACT

A liquid crystal display device includes a liquid crystal cell including a first substrate, a second substrate disposed on a viewer side to the first substrate, and a liquid crystal layer provided between the first substrate and the second substrate, and a first linear polarizer disposed on a viewer side to the liquid crystal cell, and has a plurality of pixels. Each of the pixels includes a reflective region where display is performed in a reflection mode. The liquid crystal display device does not include a λ/4 plate between the first linear polarizer and the liquid crystal layer. An in-plane retardation of the liquid crystal layer in the reflective region is configured to vary from approximately zero to approximately λ/4 depending on a voltage applied to the liquid crystal layer.

### CROSS-REFERENCE TO RELATED APPLICATIONS

This application claims the benefit of priority to U.S. Provisional Application No. 63/115,330 filed on Nov. 18, 2020. The entire contents of the above-identified application are hereby incorporated by reference.

### BACKGROUND

### Technical Field

The disclosure relates to a liquid crystal display device, and particularly relates to a liquid crystal display device in which each pixel has a reflective region.

A transflective (sometimes referred to as a “transmission/reflection dual-mode”) liquid crystal display device is capable of performing reflective display under sunlight or illumination light, and transmissive display at night, so that it is excellent in viewability indoors and outdoors and low power consumption.

In a known transflective liquid crystal display device (for example, disclosed in JP 5767195 B), both a polarizer disposed on a front face side to a liquid crystal cell (front polarizer) and a polarizer disposed on a back face side to the liquid crystal cell (back polarizer) are circular polarizers. Therefore, light of a backlight reflected by the reflective electrode and various wiring lines is absorbed by the back circular polarizer, so that usage efficiency of light (light recycling effect) is low. Note that the circular polarizer typically includes a linear polarizer and a λ/4 plate.

Therefore, it is proposed in JP 2006-330741 A that the front polarizer and the back polarizer are linear polarizers instead of circular polarizers by providing a retardation layer (phase delay film) patterned on a color filter substrate, thereby enhancing a light recycling effect of light of the backlight. The patterning retardation layer is formed by subjecting an alignment film formed on a glass substrate to mask rubbing or divisional alignment treatment by photo-alignment, applying a liquid crystal polymer having ultraviolet curing properties on the alignment film, and then photocuring the liquid crystal polymer.

### SUMMARY

However, the formation of the patterning retardation layer causes an increase in the number of members and an increase in the number of process steps, which causes a problem of increasing the manufacturing cost of the liquid crystal display device.

The disclosure has been made in view of the above problems, and an object of the disclosure is to increase the usage efficiency of light in a liquid crystal display device in which each pixel includes a reflective region without increasing the manufacturing cost.

The present specification discloses a liquid crystal display device according to the following items.

### Item 1

A liquid crystal display device having a plurality of pixels arranged in a matrix, each of the pixels includes a reflective region where display is performed in a reflection mode, the liquid crystal display device including a liquid crystal cell including a first substrate, a second substrate disposed on a viewer side to the first substrate, and a liquid crystal layer provided between the first substrate and the second substrate, and a first linear polarizer disposed on a viewer side to the liquid crystal cell, in which no λ/4 plate is provided between the first linear polarizer and the liquid crystal layer, and an in-plane retardation of the liquid crystal layer in the reflective region is configured to change from approximately zero to approximately λ/4 depending on a voltage applied to the liquid crystal layer.

### Item 2

The liquid crystal display device according to item 1, in which the liquid crystal display device performs display in an ECB mode.

### Item 3

The liquid crystal display device according to item 2, in which no λ/2 plate is provided between the first linear polarizer and the liquid crystal layer.

### Item 4

The liquid crystal display device according to item 3, in which a retardation Δnd of the liquid crystal layer in the reflective region is from 135 nm to 215 nm.

### Item 5

The liquid crystal display device according to item 3 or 4, in which an inequality of 44°≤θ_{A1}≤46° or 134°≤θ_{A1}≤136° is satisfied, where θ_{A1} is an angle formed by an absorption axis of the first linear polarizer and an orientation direction of a liquid crystal molecule of the liquid crystal layer.

### Item 6

The liquid crystal display device according to item 2, further including a λ/2 plate provided between the first linear polarizer and the liquid crystal layer.

### Item 7

The liquid crystal display device according to item 6, in which a retardation Δnd of the liquid crystal layer in the reflective region is from 120 nm to 240 nm.

### Item 8

The liquid crystal display device according to item 6 or 7, in which an inequality of 44°≤θ_{B2}−2θ_{B1}≤46° or 134°≤θ_{B2}−2θ_{B1}≤136° is satisfied, where θ_{B1} is an angle formed by the absorption axis of the first linear polarizer and a slow axis of the λ/2 plate, and θ_{B2} is an angle formed by the absorption axis of the first linear polarizer and an orientation direction of a liquid crystal molecule of the liquid crystal layer.

### Item 9

The liquid crystal display device according to any one of items 2 to 8, further including a second linear polarizer disposed on a back face side to the liquid crystal cell, in which each of the plurality of pixels further includes a transmissive region where display is performed in a transmission mode, the liquid crystal display device does not include a λ/4 plate between the second linear polarizer and the liquid crystal layer, an in-plane retardation of the liquid crystal layer in the transmissive region is configured to vary from approximately zero to approximately λ/2 depending on a voltage applied to the liquid crystal layer, and a ratio of a retardation Δnd of the liquid crystal layer in the transmissive region to a retardation Δnd of the liquid crystal layer in the reflective region is from 1.95 to 2.05.

### Item 10

The liquid crystal display device according to item 1, in which the liquid crystal display device performs display in a VA mode.

### Item 11

The liquid crystal display device according to item 10, in which no λ/2 plate is provided between the first linear polarizer and the liquid crystal layer.

### Item 12

The liquid crystal display device according to item 11, in which a retardation Δnd of the liquid crystal layer in the reflective region is from 155 nm to 255 nm.

### Item 13

The liquid crystal display device according to item 11 or 12, in which an inequality of 44°≤θ_{C1}≤46° or 134°≤θ_{C1} 136° is satisfied, where θ_{C1} is an angle formed by an absorption axis of the first linear polarizer and an orientation direction of a liquid crystal molecule of the liquid crystal layer.

### Item 14

The liquid crystal display device according to item 10, further including a λ/2 plate provided between the first linear polarizer and the liquid crystal layer.

### Item 15

The liquid crystal display device according to item 14, in which a retardation Δnd of the liquid crystal layer in the reflective region is from 135 nm to 320 nm.

### Item 16

The liquid crystal display device according to item 14 or 15, in which an inequality of 44°≤θ_{D2}−2θ_{D1}≤46° or 134°≤θ_{D2}−2θ_{D1}≤136° is satisfied, where θ_{D1} is an angle formed by an absorption axis of the first linear polarizer and a slow axis of the λ/2 plate and θ_{D2} is an angle formed by the absorption axis of the first linear polarizer and an orientation direction of a liquid crystal molecule of the liquid crystal layer.

### Item 17

The liquid crystal display device according to item 10, further including a first λ/2 plate provided between the first linear polarizer and the liquid crystal layer, and a second λ/2 plate provided between the first λ/2 plate and the liquid crystal layer.

### Item 18

The liquid crystal display device according to item 17, in which a retardation Δnd of the liquid crystal layer in the reflective region is from 140 nm to 320 nm.

### Item 19

The liquid crystal display device according to item 17 or 18, in which an inequality of 44°≤θ_{E3}−2θ_{E2}+2θ_{E1}≤46° or 134°≤θ_{E3}−2θ_{E2}+2θ_{E1}≤136° is satisfied, where θ_{E1} is an angle formed by an absorption axis of the first linear polarizer and a slow axis of the first λ/2 plate, θ_{E2} is an angle formed by the absorption axis of the first linear polarizer and a slow axis of the second λ/2 plate, and θ_{E3} is an angle formed by the absorption axis of the first linear polarizer and an orientation direction of a liquid crystal molecule of the liquid crystal layer.

### Item 20

The liquid crystal display device according to any one of items 10 to 19, further including a second linear polarizer disposed on a back face side to the liquid crystal cell, in which each of the plurality of pixels further includes a transmissive region where display is performed in a transmission mode, the liquid crystal display device does not include a λ/4 plate between the second linear polarizer and the liquid crystal layer, an in-plane retardation of the liquid crystal layer in the transmissive region is configured to vary from approximately zero to approximately λ/2 depending on a voltage applied to the liquid crystal layer, and a ratio of a retardation Δnd of the liquid crystal layer in the transmissive region to a retardation Δnd of the liquid crystal layer in the reflective region is from 2.00 to 2.05.

### Item 21

The liquid crystal display device according to item 10, further including a first λ/2 plate provided between the first linear polarizer and the liquid crystal layer, and a second λ/2 plate provided between the first λ/2 plate and the liquid crystal layer, in which a retardation of the first λ/2 plate is approximately 270 nm, and a retardation of the second λ/2 plate is approximately 250 nm.

### Item 22

The liquid crystal display device according to item 21, in which a retardation Δnd of the liquid crystal layer in the reflective region is from 125 nm to 270 nm.

### Item 23

The liquid crystal display device according to item 21 or 22, in which an inequality of 44°≤θ_{F3}−2θ_{F2}+2θ_{F1}≤46° or 134°≤θ_{F3}−2θ_{F2}+2θ_{F1}≤136° is satisfied, where θ_{F1} is an angle formed by an absorption axis of the first linear polarizer and a slow axis of the first λ/2 plate, and θ_{F2} is an angle formed by the absorption axis of the first linear polarizer and a slow axis of the second λ/2 plate, and θ_{F3} is an angle formed by the absorption axis of the first linear polarizer and an orientation direction of a liquid crystal molecule of the liquid crystal layer.

### Item 24

The liquid crystal display device according to item 10, further including a first λ/2 plate provided between the first linear polarizer and the liquid crystal layer, and a second λ/2 plate provided between the first λ/2 plate and the liquid crystal layer, in which a retardation of the first λ/2 plate is approximately 270 nm, and an inequality of 0.000833333333333303a³−0.624999999999975a²+156.66666666666a−12999.9999999994≤b≤−0.00249999999999991a³+1.84999999999993a²−452.24999999998a+36769.9999999981 is satisfied, where a retardation of the second λ/2 plate is a [nm], and a retardation Δnd of the liquid crystal layer in the reflective region is b [nm].

### Item 25

The liquid crystal display device according to item 10, further including a first λ/2 plate provided between the first linear polarizer and the liquid crystal layer, a second λ/2 plate provided between the first λ/2 plate and the liquid crystal layer, and a second linear polarizer disposed on a back face side to the liquid crystal cell, in which each of the plurality of pixels further includes a transmissive region where display is performed in a transmission mode, the liquid crystal display device does not include a λ/4 plate between the second linear polarizer and the liquid crystal layer, an in-plane retardation of the liquid crystal layer in the transmissive region is configured to vary from approximately zero to approximately λ/2 depending on a voltage applied to the liquid crystal layer, a retardation of the first λ/2 plate is approximately 270 nm, an inequality of −0.005x+3.350≤y≤−0.005x+3.400 is satisfied, where x [nm] is a retardation of the second λ/2, and y is a ratio of a retardation Δnd of the liquid crystal layer in the transmissive region to a retardation Δnd of the liquid crystal layer in the reflective region.

### Item 26

The liquid crystal display device according to any one of items 1 to 25, in which in a case in which the in-plane retardation of the liquid crystal layer in the reflective region is approximately λ/4, in a case in which a polarized light with a Stokes parameter S3 having an absolute value |S3| of 0 is incident on the liquid crystal layer in the reflective region, |S3| of the polarized light passing through the liquid crystal layer in the reflective region is 0.999 or greater.

### Item 27

The liquid crystal display device according to any one of items 1 to 8, 10 to 19, 21 to 24, and 26, further including a second linear polarizer disposed on a back face side to the liquid crystal cell, in which each of the plurality of pixels further includes a transmissive region where display is performed in a transmission mode, and the liquid crystal display device does not include a λ/4 plate between the second linear polarizer and the liquid crystal layer, and an in-plane retardation of the liquid crystal layer in the transmissive region is configured to vary from approximately zero to approximately λ/2 depending on a voltage applied to the liquid crystal layer.

According to the embodiments of the disclosure, in a liquid crystal display device in which each pixel includes a reflective region, the usage efficiency of light can be increased without increasing the manufacturing cost.

### BRIEF DESCRIPTION OF DRAWINGS

The disclosure will be described with reference to the accompanying drawings, wherein like numbers reference like elements.

FIG. 1 is a cross-sectional view schematically illustrating a liquid crystal display device 100 according to an embodiment of the disclosure.

FIG. 2 is a diagram for explaining a display principle of the liquid crystal display device 100.

FIG. 3 is a cross-sectional view schematically illustrating another liquid crystal display device 200 according to an embodiment of the disclosure.

FIG. 4A is a cross-sectional view schematically illustrating a liquid crystal display device 100A according to Example 1.

FIG. 4B is a diagram illustrating an axis setting in the liquid crystal display device 100A.

FIG. 5A is a cross-sectional view schematically illustrating a liquid crystal display device 100B according to Example 2.

FIG. 5B is a diagram illustrating an axis setting in the liquid crystal display device 100B.

FIG. 6A is a cross-sectional view schematically illustrating a liquid crystal display device 100C according to Example 3.

FIG. 6B is a diagram illustrating an axis setting in the liquid crystal display device 100C.

FIG. 7A is a cross-sectional view schematically illustrating a liquid crystal display device 100D according to Example 4.

FIG. 7B is a diagram illustrating an axis setting in the liquid crystal display device 100D.

FIG. 8A is a cross-sectional view schematically illustrating a liquid crystal display device 100E according to Example 5.

FIG. 8B is a diagram illustrating an axis setting in the liquid crystal display device 100E.

FIG. 9A is a cross-sectional view schematically illustrating a liquid crystal display device 100F according to Example 6.

FIG. 9B is a diagram illustrating an axis setting in the liquid crystal display device 100F.

FIG. 10A is a cross-sectional view schematically illustrating a liquid crystal display device 200A according to Example 7.

FIG. 10B is a diagram illustrating an axis setting in the liquid crystal display device 200A.

FIG. 11A is a cross-sectional view schematically illustrating a liquid crystal display device 900 according to Comparative Example.

FIG. 11B is a diagram illustrating an axis setting in the liquid crystal display device 900.

FIG. 12A is a graph showing relationships between a retardation Δnd of a liquid crystal layer 30 in a reflective region Rf and a reflection contrast ratio and a reflectivity ratio in Example 1.

FIG. 12B is a graph showing relationships between a retardation Δnd of the liquid crystal layer 30 in the reflective region Rf and the reflection contrast ratio and the reflectivity ratio in Example 2.

FIG. 12C is a graph showing relationships between a retardation Δnd of the liquid crystal layer 30 in the reflective region Rf and the reflection contrast ratio and the reflectivity ratio in Example 3.

FIG. 12D is a graph showing relationships between a retardation Δnd of the liquid crystal layer 30 in the reflective region Rf and the reflection contrast ratio and the reflectivity ratio in Example 4.

FIG. 12E is a graph showing relationships between a retardation Δnd of the liquid crystal layer 30 in the reflective region Rf and the reflection contrast ratio and the reflectivity ratio in Example 5.

FIG. 12F is a graph showing relationships between a retardation Δnd of the liquid crystal layer 30 in the reflective region Rf and the reflection contrast ratio and the reflectivity ratio in Example 6.

FIG. 12G is a graph showing a relationship between a retardation of a second λ/2 plate 43B and a suitable range of a retardation Δnd of the liquid crystal layer 30 in the reflective region Rf.

FIG. 13A is a graph showing a relationship between an angle θ_{A1} formed by an absorption axis PA1 of a front linear polarizer 41 and an orientation direction LA of a liquid crystal molecule and a Stokes parameter S3 in Example 1.

FIG. 13B is a graph showing the relationship between the angle θ_{A1} formed by the absorption axis PA1 of the front linear polarizer 41 and the orientation direction LA of the liquid crystal molecule and the Stokes parameter S3 in Example 1.

FIG. 14A is a graph showing a relationship between an angle θ_{B1} formed by the absorption axis PA1 of the front linear polarizer 41 and a slow axis SA1 of the λ/2 plate 43, an angle θ_{B2} formed by the absorption axis PA1 of the front linear polarizer 41 and the orientation direction LA of the liquid crystal molecule, and the Stokes parameter S3 in Example 2.

FIG. 14B is a graph showing the relationship between the angle θ_{B1} formed by the absorption axis PA1 of the front linear polarizer 41 and the slow axis SA1 of the λ/2 plate 43, the angle θ_{B2} formed by the absorption axis PA1 of the front linear polarizer 41 and the orientation direction LA of the liquid crystal molecule, and the Stokes parameter S3 in Example 2.

FIG. 15A is a graph showing a relationship between an angle θ_{C1} formed by the absorption axis PA1 of the front linear polarizer 41 and the orientation direction LA of the liquid crystal molecule and the Stokes parameter S3 in Example 3.

FIG. 15B is a graph showing the relationship between the angle θ_{C1} formed by the absorption axis PA1 of the front linear polarizer 41 and the orientation direction LA of the liquid crystal molecule and the Stokes parameter S3 in Example 3.

FIG. 16A is a graph showing a relationship between an angle θ_{D1} formed by the absorption axis PA1 of the front linear polarizer 41 and the slow axis SA1 of the λ/2 plate 43, an angle θ_{D2} formed by the absorption axis PA1 of the front linear polarizer 41 and the orientation direction of the liquid crystal molecule, and the Stokes parameter S3 in Example 4.

FIG. 16B is a graph showing the relationship between the angle θ_{D1} formed by the absorption axis PA1 of the front linear polarizer 41 and the slow axis SA1 of the λ/2 plate 43, the angle θ_{D2} formed by the absorption axis PA1 of the front linear polarizer 41 and the orientation direction of the liquid crystal molecule, and the Stokes parameter S3 in Example 4.

FIG. 17A is a graph showing a relationship between an angle θ_{E1} formed by the absorption axis PA1 of the front linear polarizer 41 and a slow axis SA1 of a first λ/2 plate 43A, an angle θ_{E2} formed by the absorption axis PA1 of the front linear polarizer 41 and a slow axis SA2 of the second λ/2 plate 43B, an angle θ_{E3} formed by the absorption axis PA1 of the front linear polarizer 41 and the orientation direction of the liquid crystal molecule, and the Stokes parameter S3 in Example 5.

FIG. 17B is a graph showing the relationship between the angle θ_{E1} formed by the absorption axis PA1 of the front linear polarizer 41 and the slow axis SA1 of the first λ/2 plate 43A, the angle θ_{E2} formed by the absorption axis PA1 of the front linear polarizer 41 and the slow axis SA2 of the second λ/2 plate 43B, the angle θ_{E3} formed by the absorption axis PA1 of the front linear polarizer 41 and the orientation direction of the liquid crystal molecule, and the Stokes parameter S3 in Example 5.

FIG. 18A is a graph showing a relationship between an angle θ_{F1} formed by the absorption axis PA1 of the front linear polarizer 41 and the slow axis SA1 of the first λ/2 plate 43A, an angle θ_{F2} formed by the absorption axis PA1 of the front linear polarizer 41 and the slow axis SA2 of the second λ/2 plate 43B, an angle θ_{F3} formed by the absorption axis PA1 of the front linear polarizer 41 and the orientation direction of the liquid crystal molecule, and the Stokes parameter S3 in Example 6.

FIG. 18B is a graph showing the relationship between the angle θ_{F1} formed by the absorption axis PA1 of the front linear polarizer 41 and the slow axis SA1 of the first λ/2 plate 43A, the angle θ_{F2} formed by the absorption axis PA1 of the front linear polarizer 41 and the slow axis SA2 of the second λ/2 plate 43B, the angle θ_{F3} formed by the absorption axis PA1 of the front linear polarizer 41 and the orientation direction of the liquid crystal molecule, and the Stokes parameter S3 in Example 6.

FIG. 19A is a graph showing a relationship between a liquid crystal layer retardation ratio and a normalized transmission contrast for Example 1.

FIG. 19B is a graph showing a relationship between a liquid crystal layer retardation ratio and a normalized transmission contrast for Example 2.

FIG. 20A is a graph showing a relationship between a liquid crystal layer retardation ratio and a normalized transmission contrast for Example 3.

FIG. 20B is a graph showing a relationship between a liquid crystal layer retardation ratio and a normalized transmission contrast for Example 4.

FIG. 20C is a graph showing a relationship between a liquid crystal layer retardation ratio and a normalized transmission contrast for Example 5.

FIG. 21A is a graph showing a relationship between a liquid crystal layer retardation ratio and a normalized transmission contrast when the retardation of the second λ/2 plate 43B is 240 nm in Example 6.

FIG. 21B is a graph showing a relationship between a liquid crystal layer retardation ratio and a normalized transmission contrast when the retardation of the second λ/2 plate 43B is 250 nm in Example 6.

FIG. 21C is a graph showing a relationship between a liquid crystal layer retardation ratio and a normalized transmission contrast when the retardation of the second λ/2 plate 43B is 260 nm in Example 6.

FIG. 22 is a graph showing a relationship between the retardation of the second λ/2 plate 43B and a suitable liquid crystal layer retardation ratio.

FIG. 23 is a graph showing a relationship between a voltage applied to the liquid crystal layer 30 and a normalized reflectivity for each of Examples 1 to 6 and Comparative Example.

FIG. 24 is a graph showing a relationship between the voltage applied to the liquid crystal layer 30 and a normalized transmittance for each of Examples 1 to 6 and Comparative Example.

### DESCRIPTION OF EMBODIMENTS

Hereinafter, embodiments of the disclosure will be described with reference to the accompanying drawings. The disclosure is not limited to the embodiments described below.

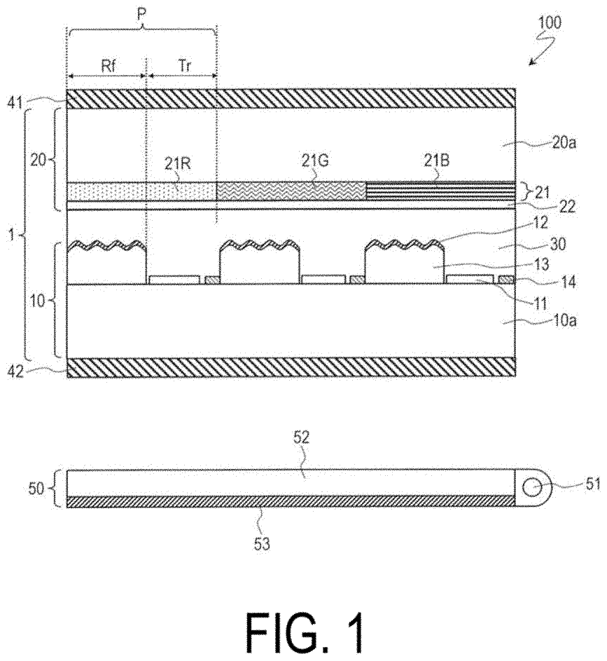

A liquid crystal display device 100 according to the embodiment of the disclosure will be described with reference to FIG. 1. The liquid crystal display device 100 includes a liquid crystal cell 1, a first linear polarizer (front linear polarizer) 41 disposed on a viewer side (front face side) to the liquid crystal cell 1, a second linear polarizer (back linear polarizer) 42 disposed on a back face side to the liquid crystal cell 1, and a backlight (illumination device) 50 disposed on a back face side to the second linear polarizer 42. The liquid crystal display device 100 has a plurality of pixels P arranged in a matrix. Each of the plurality of pixels P includes a reflective region Rf where display is performed in a reflection mode, and a transmissive region Tr where display is performed in a transmission mode. In other words, the liquid crystal display device 100 is a transflective (transmission/reflection dual-mode) liquid crystal display device.

The liquid crystal cell 1 includes an active matrix substrate (hereinafter, referred to as “TFT substrate”) 10, a color filter substrate 20 (also referred to as “counter substrate”) disposed on a viewer side to the TFT substrate 10, and a liquid crystal layer 30 provided between the TFT substrate 10 and the color filter substrate 20.

The liquid crystal display device 100 does not include a λ/4 plate between the first linear polarizer 41 and the liquid crystal layer 30. In addition, the liquid crystal display device 100 does not include a λ/4 plate between the second linear polarizer 42 and the liquid crystal layer 30.

An in-plane retardation of the liquid crystal layer 30 in the reflective region Rf and an in-plane retardation of the liquid crystal layer 30 in the transmissive region Tr vary in accordance with a voltage applied to the liquid crystal layer 30. Specifically, the in-plane retardation of the liquid crystal layer 30 in the reflective region Rf may vary from approximately zero to approximately λ/4 (¼ wavelength) depending on the voltage applied to the liquid crystal layer 30. In addition, the in-plane retardation of the liquid crystal layer 30 in the transmissive region Tr may vary from approximately zero to approximately λ/2 (½ wavelength) depending on the voltage applied to the liquid crystal layer 30.

Alignment films (not illustrated) are formed on the outermost surfaces of the TFT substrate 10 and the color filter substrate 20 on the liquid crystal layer 30 side. The alignment film is subjected to an alignment treatment. As the alignment treatment, for example, a rubbing treatment or a photo-alignment treatment is used. The alignment film defines the orientation direction of the liquid crystal molecule of the liquid crystal layer 30.

As the display mode, an Electrically Controlled Birefringence (ECB) mode or a Vertical Alignment (VA)-ECB mode (sometimes simply referred to as a VA mode) is used. Hereinafter, the configuration using the ECB mode is referred to as a “first embodiment”, and the configuration using the VA-ECB mode is referred to as a “second embodiment”. When using the ECB mode (i.e., in the first embodiment), the liquid crystal layer 30 is composed of a positive liquid crystal material. When using the VA-ECB mode (i.e., in the second embodiment), the liquid crystal layer 30 is composed of a negative liquid crystal material. A thickness of the liquid crystal layer 30 (cell gap) in the transmissive region Tr is preferably greater than a thickness of the liquid crystal layer 30 in the reflective region Rf (for example, approximately twice).

The TFT substrate 10 includes a transparent electrode 11 provided in the transmissive region Tr and a reflective electrode 12 provided in the reflective region Rf. The transparent electrode 11 is formed of a transparent conductive material (for example, ITO or IZO). The reflective electrode 12 is formed of a metal material having high reflectivity (for example, aluminum or a silver alloy). The reflective electrode 12 has concave-convex structure (Micro Reflective Structure: MRS) on a surface thereof. MRS can be obtained by forming an uneven shape on an organic insulating layer 13 by photolithography, and forming the reflective electrode 12 thereon (for example, sputtering a metal material having high reflectivity). In MRS, external light can be scattered in a certain angular range. Therefore, ambient light can be efficiently utilized, and a bright reflective display can be obtained. Note that a transparent conductive film formed of ITO or IZO may be provided as a protection layer on an upper layer of the reflective electrode 12.

In addition, a thin film transistor (not illustrated), a gate wiring line (not illustrated), a source wiring line 14, and the like are provided in a lower layer (backlight 50 side) below the reflective electrode 12 with an interlayer insulating layer interposed therebetween. By reflecting part of light from the backlight 50 toward the backlight 50 by the reflective electrode 12 and various wiring lines, the reflected light can be recycled. Further, a reflective layer for recycling light may be formed closer to the backlight 50 than the reflective electrode 12. As a material of the reflective layer, a metal having high reflectivity such as aluminum or a silver alloy can be used as in the case of the reflective electrode 12. The above-mentioned constituent elements of the TFT substrate 10 are supported by a transparent substrate (e.g., a glass substrate) 10a having an insulating property.

The color filter substrate 20 includes a color filter layer 21 and a counter electrode 22 provided on the color filter layer 21. An overcoat layer (flattening layer) may be provided between the color filter layer 21 and the counter electrode 22. The color filter layer 21 typically includes a red color filter 21R, a green color filter 21G, and a blue color filter 21B. A black matrix (light blocking layer) may be provided between the color filters of different colors, but it is preferable not to provide the black matrix from the perspective of obtaining a brighter display. The above-mentioned constituent elements of the color filter substrate 20 are supported by a transparent substrate (e.g., a glass substrate) 20a having an insulating property.

The first linear polarizer (front linear polarizer) 41 is an absorbing linear polarizer. As the absorbing linear polarizer, a linear polarizer composed of a film polarizing plate dyed and stretched with polyvinyl alcohol (PVA) and a triacetyl cellulose (TAC) protection layer, a dye-based polarizer, a coated polarizer, and the like can be used. The absorbing linear polarizer has a transmission axis and an absorption axis orthogonal to the transmission axis. One or two λ/2 plates may be disposed between the first linear polarizer 41 and the liquid crystal layer 30. By disposing one or two λ/2 plates between the first linear polarizer 41 and the liquid crystal layer 30, contrast and a viewing angle characteristic can be improved. Note that the retardations of the λ/2 plate and the liquid crystal layer 30 may be referred to in the present specification, where the “retardation” means “in-plane retardation” unless otherwise specified.

As the second linear polarizer (back linear polarizer) 42, an absorbing linear polarizer can be used in the same manner as the front linear polarizer 41. In addition, a reflective linear polarizer or a layered body of an absorbing linear polarizer and a reflective linear polarizer may be used. Examples of the reflective linear polarizer include a multilayer reflective polarizer (trade name: DBEF) manufactured by Sumitomo 3M Ltd., or a combination of a cholesteric LC film and a λ/4 plate. Unlike the absorbing linear polarizer, the reflective linear polarizer has a reflection axis in a direction orthogonal to the transmission axis. Thus, part of the light from backlight 50 is reflected by the reflective linear polarizer and further reflected by a reflector 53 included in the backlight 50. Note that the reflective linear polarizer may be included in the backlight 50 instead of the back linear polarizer 42.

The backlight 50 includes a light source (for example, an LED) 51 that emits light, a light guide plate 52 that guides the light from the light source 51 toward the liquid crystal cell 1, and the reflector 53 disposed on the back face side of the light guide plate 52. The backlight 50 may further include a prism sheet and a diffuser sheet disposed on the front face side (or back face side) of the light guide plate 52.

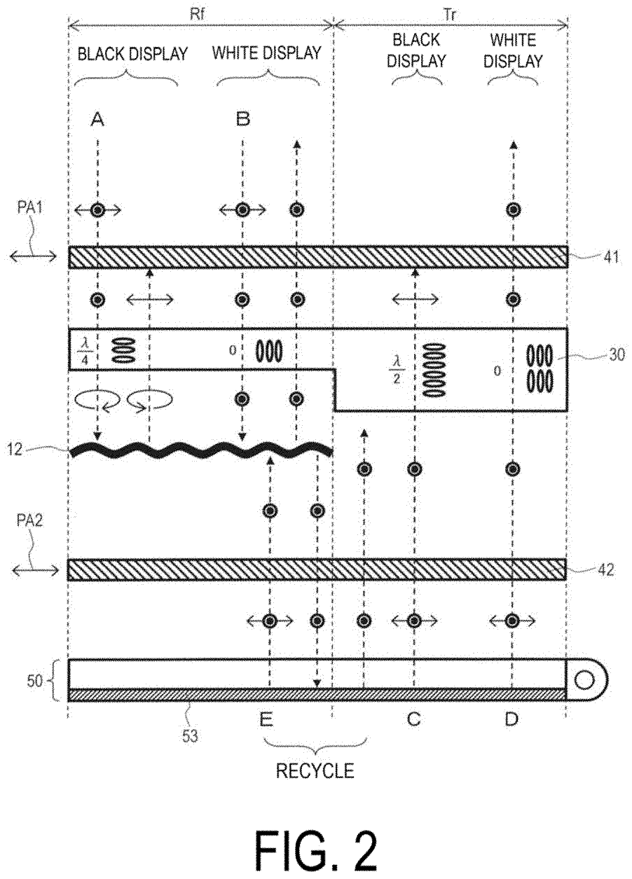

A display principle of the liquid crystal display device 100 will be described with reference to FIG. 2. Here, a case in which the ECB mode is used as a display mode (that is, the “first embodiment”) will be described as an example. In the ECB mode, a black display (liquid crystal molecules are horizontally aligned) is obtained in a state where no voltage is applied to the liquid crystal layer 30. At this time, an in-plane retardation of the liquid crystal layer 30 in the reflective region Rf is approximately λ/4, and an in-plane retardation of the liquid crystal layer 30 in the transmissive region Tr is approximately λ/2. In addition, a white display (liquid crystal molecules are vertically aligned) is obtained in a state where a predetermined voltage is applied to the liquid crystal layer 30. At this time, the in-plane retardation of the liquid crystal layer 30 is approximately zero. Such a display form is referred to as a normally black mode.

Note that in a case of the VA-ECB mode (“second embodiment”), the white display (liquid crystal molecules are vertically aligned) is obtained in a state where no voltage is applied to the liquid crystal layer 30. At this time, the in-plane retardation of the liquid crystal layer 30 is approximately zero. In addition, the black display (liquid crystal molecules are horizontally aligned) is obtained in a state where a predetermined voltage is applied to the liquid crystal layer 30. At this time, the in-plane retardation of the liquid crystal layer 30 in the reflective region Rf is approximately λ/4, and the in-plane retardation of the liquid crystal layer 30 in the transmissive region Tr is approximately λ/2. Such a display form is referred to as a normally white mode.

### Black Display in Reflective Region Rf: Optical Path A

External light (ambient light), which is unpolarized light, becomes an S wave (double circle) by passing through the front linear polarizer 41 (having the absorption axis PA1). Since the liquid crystal layer 30 is in the horizontal alignment state (functions as a positive A plate) and has an in-plane retardation of approximately λ/4 (¼ wavelength) when no voltage is applied, the S wave that has passed through the front linear polarizer 41 is converted to left handed circularly-polarized light after passing through the liquid crystal layer 30. The left handed circularly-polarized light is then converted to right handed circularly-polarized light when reflected by the reflective electrode 12. The right handed circularly-polarized light is converted to a P wave (double-headed arrow) after passing through the liquid crystal layer 30. Since the polarization direction of the P wave coincides with the absorption axis PA1 of the front linear polarizer 41, the P wave is absorbed by the front linear polarizer 41. In this manner, the black display is obtained in the reflective region Rf.

### White Display in Reflective Region Rf: Optical Path B

External light, which is unpolarized light, becomes the S wave (double circle) by passing through the front linear polarizer 41. Since the liquid crystal layer 30 is in a vertical alignment state (functions as a positive C plate) and has little in-plane retardation (approximately zero) when a voltage is applied, the S wave that has passed through the front linear polarizer 41 passes through the liquid crystal layer 30 while maintaining the polarization state as it is. The S wave subsequently maintains the same polarization state when reflected by the reflective electrode 12 and after re-passing through the liquid crystal layer 30. Since the polarization direction of the S wave that has re-passed through the liquid crystal layer 30 coincides with the transmission axis of the front linear polarizer 41, the S wave passes through the front linear polarizer 41. In this manner, the white display is obtained in the reflective region Rf.

### Black Display in Transmissive Region Tr: Optical Path C

Light of the backlight, which is unpolarized light (strictly speaking, it may be polarized to some extent by a prism sheet) becomes the S wave (double circle) by passing through the back linear polarizer (having the absorption axis PA2) 42. Since the liquid crystal layer 30 is in a horizontal alignment state (functions as a positive A plate) and has an in-plane retardation of approximately λ/2 (½ wavelength) when no voltage is applied, the S wave that has passed through the back linear polarizer 42 is converted to the P wave (double-headed arrow) after passing through the liquid crystal layer 30. Since the polarization direction of the P wave coincides with the absorption axis PA1 of the front linear polarizer 41, the P wave is absorbed by the front linear polarizer 41. In this manner, the black display is obtained in the transmissive region Tr.

### White Display in Transmissive Region Tr: Optical Path D

Light of the backlight, which is unpolarized light, becomes an S wave (double circle) by passing through the back linear polarizer 42. Since the liquid crystal layer 30 is in a vertical alignment state (functions as a positive C plate) and has little in-plane retardation (approximately zero) when a voltage is applied, the S wave that has passed through the back linear polarizer 42 passes through the liquid crystal layer 30 while maintaining the polarization state as it is. Since the polarization direction of the S wave that has passed through the liquid crystal layer coincides with the transmission axis of the front linear polarizer 41, the S wave passes through the front linear polarizer 41. In this manner, the white display is obtained in the transmissive region Tr.

### Recycle Light: Optical Path E

Light of the backlight, which is unpolarized light, becomes the S wave (double circle) by passing through the back linear polarizer 42. The reflective electrode 12 reflects the S wave as it is. The reflected light from the reflective electrode 12 passes through the back linear polarizer 42 while maintaining its polarization state, is reflected by the reflector 53 of the backlight 50, and then re-passes the transmission axis of the back linear polarizer 42, and is reused as the light for the transmissive display.

As described above, in the liquid crystal display device 100 according to the embodiment of the disclosure, the in-plane retardation of the liquid crystal layer 30 in the reflective region Rf may vary from approximately zero to approximately λ/4 in accordance with the voltage applied to the liquid crystal layer 30. Accordingly, a λ/4 plate for producing the circularly-polarized light required for the black display in the reflective region Rf is not required outside the liquid crystal cell 1. For this reason, it is possible to use the linear polarizers 41 and 42 for both the front polarizer and the back polarizer instead of the circular polarizers. On the other hand, the in-plane retardation of the liquid crystal layer 30 in the transmissive region Tr may vary from approximately zero to approximately λ/2 in accordance with the voltage applied to the liquid crystal layer 30. As a result, a sufficiently bright display in the transmission mode can be obtained. In addition, since the back polarizer is the linear polarizer 42, it is possible to recycle the reflected light of the backlight from the reflective electrode 12 and the various wiring lines, whereby a brighter transmissive display can be obtained. Furthermore, unlike JP 2006-330741 A, it is not necessary to form the patterning retardation layer in the liquid crystal cell 1, so that the manufacturing cost can be reduced.

As described above, according to the embodiments of the disclosure, it is possible to increase the usage efficiency of light without increasing the manufacturing cost.

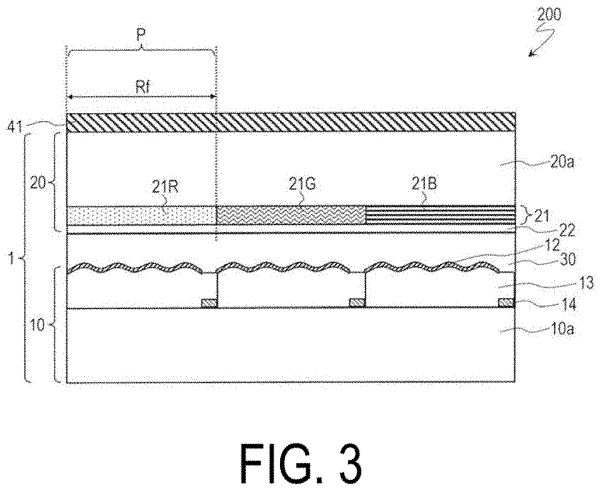

FIG. 3 illustrates another liquid crystal display device 200 according to an embodiment (hereinafter referred to as “third embodiment”) of the disclosure. The liquid crystal display device 200 includes a liquid crystal cell 1 and a linear polarizer (front linear polarizer) 41 disposed on a viewer side to the liquid crystal cell 1. The liquid crystal display device 200 has a plurality of pixels P arranged in a matrix. Each of the plurality of pixels P includes a reflective region Rf where display is performed in a reflection mode, but does not include a region where display is performed in the transmission mode (transmissive region). In other words, the liquid crystal display device 200 is a reflective liquid crystal display device.

The liquid crystal cell 1 includes an active matrix substrate (TFT substrate) 10, a color filter substrate (counter substrate) disposed on a viewer side to the TFT substrate 10, and a liquid crystal layer 30 provided between the TFT substrate 10 and the color filter substrate 20.

The liquid crystal display device 200 does not include a λ/4 plate between the linear polarizer 41 and the liquid crystal layer 30. An in-plane retardation of the liquid crystal layer 30 in the reflective region Rf varies depending on the voltage applied to the liquid crystal layer 30. Specifically, the in-plane retardation of the liquid crystal layer 30 in the reflective region Rf may vary from approximately zero to approximately λ/4 depending on the voltage applied to the liquid crystal layer 30. As a display mode, the ECB mode or the VA-ECB mode can be used.

The TFT substrate 10 includes a reflective electrode 12 provided in the reflective region Rf. The reflective electrode 12 formed on an organic insulating layer 13 has MRS. A thin film transistor (not illustrated), a gate wiring line (not illustrated), a source wiring line 14, and the like are provided in a lower layer below the reflective electrode 12 with an interlayer insulating layer interposed therebetween. The above-mentioned constituent elements of the TFT substrate 10 are supported by a transparent substrate (e.g., a glass substrate) 10a having an insulating property.

The color filter substrate 20 includes a color filter layer 21 and a counter electrode 22 provided on the color filter layer 21. An overcoat layer (flattening layer) may be provided between the color filter layer 21 and the counter electrode 22. The color filter layer 21 typically includes a red color filter 21R, a green color filter 21G, and a blue color filter 21B. The above-mentioned constituent elements of the color filter substrate 20 are supported by a transparent substrate (e.g., a glass substrate) 20a having an insulating property.

The linear polarizer (front linear polarizer) 41 is an absorbing linear polarizer. The absorbing linear polarizer has a transmission axis and an absorption axis orthogonal to the transmission axis. One or two λ/2 plates may be disposed between the linear polarizer 41 and the liquid crystal layer 30.

Since a display principle of the liquid crystal display device 200 can be readily understood from the description of the optical paths A and B for the liquid crystal display device 100, the description thereof will be omitted here.

As described above, in the liquid crystal display device 200 according to the embodiment of the disclosure, the in-plane retardation of the liquid crystal layer 30 in the reflective region Rf may vary from approximately zero to approximately λ/4 in accordance with the voltage applied to the liquid crystal layer 30. Accordingly, a λ/4 plate for producing the circularly-polarized light required for the black display in the reflective region Rf is not required outside the liquid crystal cell 1. For this reason, it is possible to use the linear polarizer 41 for the front polarizer instead of a circular polarizer. In addition, as will be described later, the liquid crystal display device 200 can have higher reflectivity (that is, higher usage efficiency of light) than a known reflective liquid crystal display device provided with a circular polarizer.

Next, examples of more specific configurations of the liquid crystal display devices 100 and 200 according to the embodiments of the disclosure will be described in Examples 1 to 7.

### Example 1

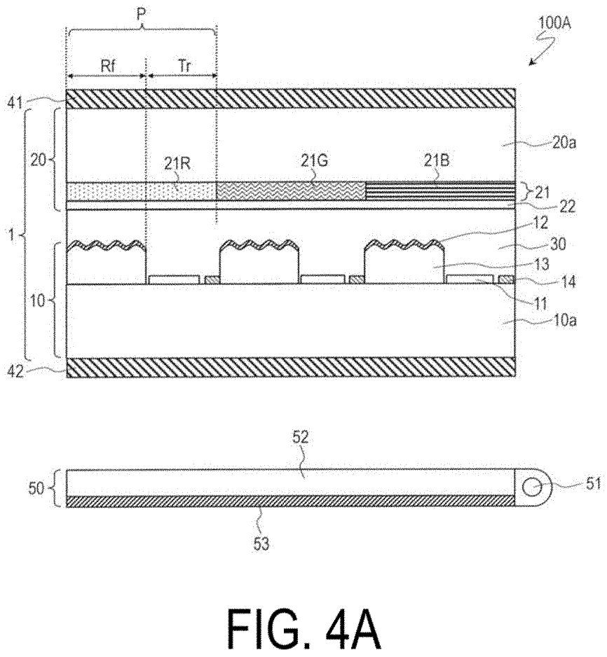

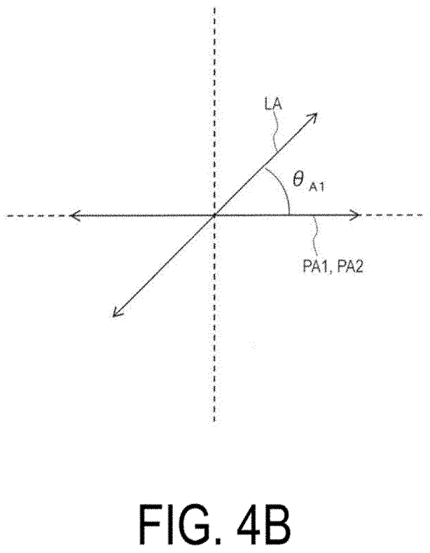

FIG. 4A illustrates a liquid crystal display device 100A according to the present example. The liquid crystal display device 100A is a specific example of the first embodiment.

The display mode of the liquid crystal display device 100A is the ECB mode. As illustrated in FIG. 4A, the liquid crystal display device 100A does not have a λ/2 plate between the first linear polarizer 41 and the liquid crystal layer 30. A retardation Δnd of the liquid crystal layer 30 (Δn is a birefringence index of the liquid crystal material and d is a thickness of the liquid crystal layer 30) is 160 nm in the reflective region Rf and 328 nm in the transmissive region Tr.

FIG. 4B is a diagram illustrating an arrangement relationship of an orientation direction LA of the liquid crystal molecule and the absorption axis PA2 of the back linear polarizer 42 with reference to the absorption axis PA1 of the front linear polarizer 41. An angle θ_{A1} formed by the absorption axis PA1 of the front linear polarizer 41 and the orientation direction LA of the liquid crystal molecule is 45°, and an angle θ_{A2} formed by the absorption axis PA1 of the front linear polarizer 41 and the absorption axis PA2 of the back linear polarizer 42 is 0°.

### Example 2

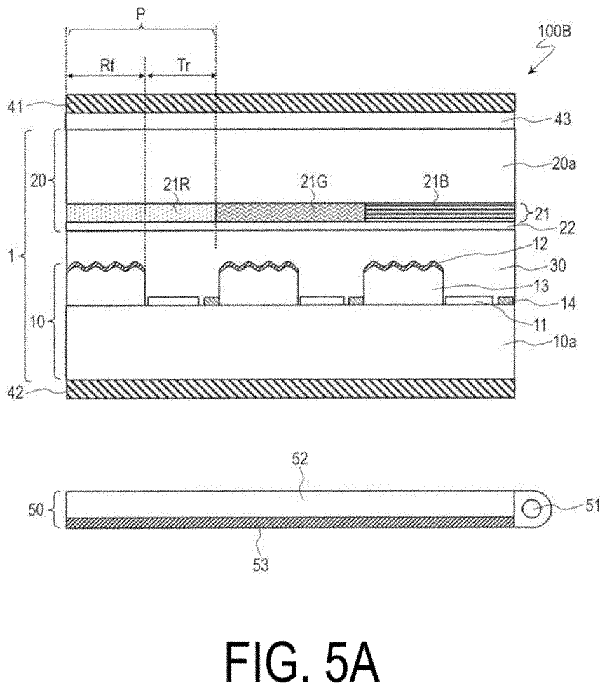

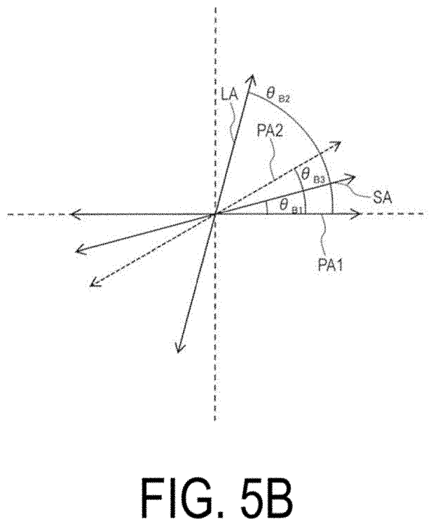

FIG. 5A illustrates a liquid crystal display device 100B according to the present example. The liquid crystal display device 100B is another specific example of the first embodiment.

The display mode of the liquid crystal display device 100B is the ECB mode. As illustrated in FIG. 5A, the liquid crystal display device 100B includes a λ/2 plate 43 provided between the front linear polarizer 41 and the liquid crystal layer 30. A retardation of the λ/2 plate 43 is 270 nm. Retardations Δnd of the liquid crystal layer 30 are 160 nm in the reflective region Rf and 320 nm in the transmissive region Tr.

FIG. 5B is a diagram illustrating an arrangement relationship of a slow axis SA of the λ/2 plate 43, the orientation direction LA of the liquid crystal molecule, and the absorption axis PA2 of the back linear polarizer 42 with reference to the absorption axis PA1 of the front linear polarizer 41. An angle θ_{B1} formed by the absorption axis PA1 of the front linear polarizer 41 and the slow axis SA of the λ/2 plate 43 is 15°. An angle θ_{B2} formed by the absorption axis PA1 of the front linear polarizer 41 and the orientation direction LA of the liquid crystal molecule is 75°, and an angle θ_{B3} formed by the absorption axis PA1 of the front linear polarizer 41 and the absorption axis PA2 of the back linear polarizer 42 is 30°.

### Example 3

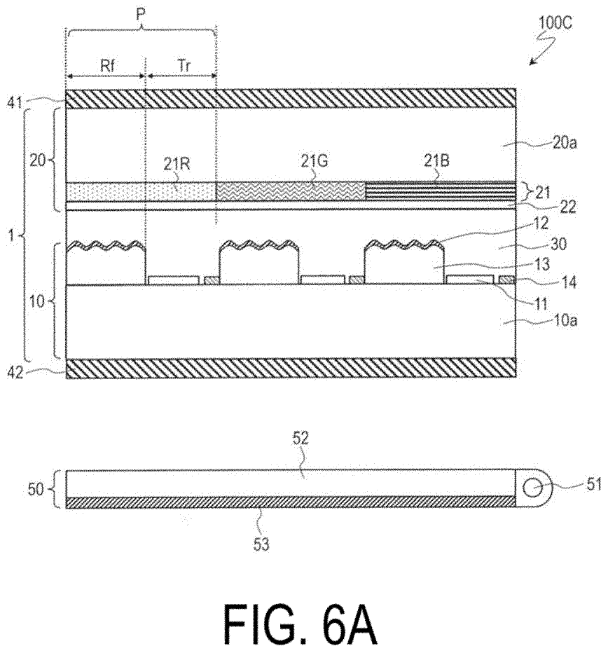

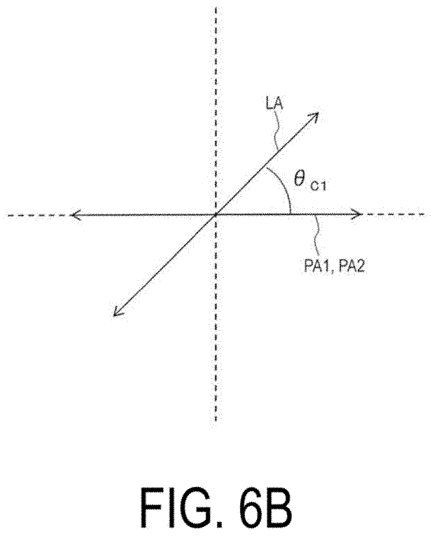

FIG. 6A illustrates a liquid crystal display device 100C according to the present example. The liquid crystal display device 100C is a specific example of the second embodiment.

The display mode of the liquid crystal display device 100C is the VA-ECB mode. As illustrated in FIG. 6A, the liquid crystal display device 100C does not have a λ/2 plate between the first linear polarizer 41 and the liquid crystal layer 30. Retardations Δnd of the liquid crystal layer 30 are 190 nm in the reflective region Rf and 380 nm in the transmissive region Tr.

FIG. 6B is a diagram illustrating an arrangement relationship of the orientation direction LA of the liquid crystal molecule and the absorption axis PA2 of the back linear polarizer 42 with reference to the absorption axis PA1 of the front linear polarizer 41. An angle θ_{C1} formed by the absorption axis PA1 of the front linear polarizer 41 and the orientation direction LA of the liquid crystal molecule is 45°, and an angle θ_{C2} formed by the absorption axis PA1 of the front linear polarizer 41 and the absorption axis PA2 of the back linear polarizer 42 is 0°.

### Example 4

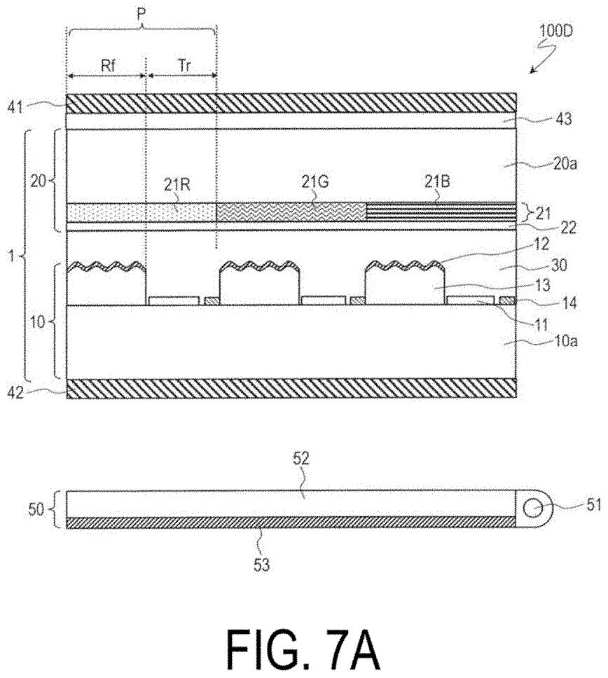

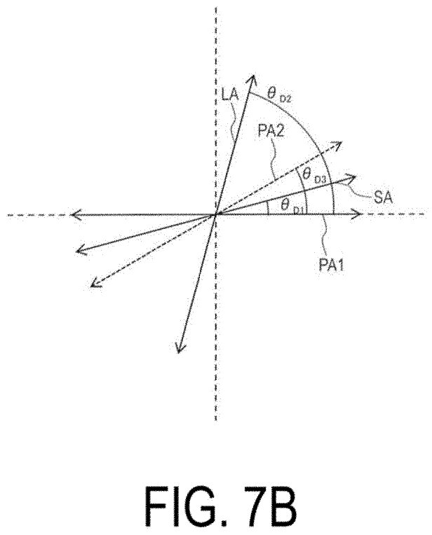

FIG. 7A illustrates a liquid crystal display device 100D according to the present example. The liquid crystal display device 100D is another specific example of the second embodiment.

The display mode of the liquid crystal display device 100D is the VA-ECB mode. As illustrated in FIG. 7A, the liquid crystal display device 100D includes the λ/2 plate 43 provided between the front linear polarizer 41 and the liquid crystal layer 30. A retardation of the λ/2 plate 43 is 270 nm. Retardations Δnd of the liquid crystal layer 30 are 190 nm in the reflective region Rf and 380 nm in the transmissive region Tr.

FIG. 7B is a diagram illustrating an arrangement relationship of the slow axis SA of the λ/2 plate 43, the orientation direction LA of the liquid crystal molecule, and the absorption axis PA2 of the back linear polarizer 42 with reference to the absorption axis PA1 of the front linear polarizer 41. An angle θ_{D1} formed by the absorption axis PA1 of the front linear polarizer 41 and the slow axis SA of the λ/2 plate 43 is 15°. An angle θ_{D2} formed by the absorption axis PA1 of the front linear polarizer 41 and the orientation direction LA of the liquid crystal molecule is 75°, and an angle θ_{D3} formed by the absorption axis PA1 of the front linear polarizer 41 and the absorption axis PA2 of the back linear polarizer 42 is 30°.

### Example 5

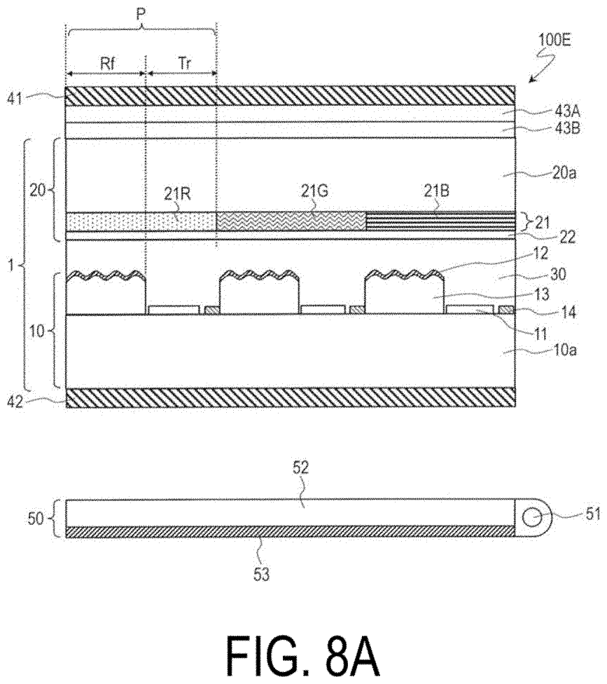

FIG. 8A illustrates a liquid crystal display device 100E according to the present example. The liquid crystal display device 100E is yet another specific example of the second embodiment.

The display mode of the liquid crystal display device 100E is the VA-ECB mode. As illustrated in FIG. 8A, the liquid crystal display device 100E includes a first λ/2 plate 43A provided between the front linear polarizer 41 and the liquid crystal layer 30, and a second λ/2 plate 43B provided between the first λ/2 plate 43A and the liquid crystal layer 30. A retardation of the first λ/2 plate 43A is 270 nm. A retardation of the second λ/2 plate 43B is 270 nm. Retardations Δnd of the liquid crystal layer 30 are 190 nm in the reflective region Rf and 380 nm in the transmissive region Tr.

FIG. 8B is a diagram illustrating an arrangement relationship of a slow axis SA1 of the first λ/2 plate 43A, a slow axis SA2 of the second λ/2 plate 43A, the orientation direction LA of the liquid crystal molecule, and the absorption axis PA2 of the back linear polarizer 42 with reference to the absorption axis PA1 of the front linear polarizer 41. An angle θ_{E1} formed by the absorption axis PA1 of the front linear polarizer 41 and the slow axis SA1 of the first λ/2 plate 43A is 7.5°, and an angle θ_{E2} formed by the absorption axis PA1 of the front linear polarizer 41 and the slow axis SA2 of the second λ/2 plate 43B is 35°. An angle θ_{E3} formed by the absorption axis PA1 of the front linear polarizer 41 and the orientation direction LA of the liquid crystal molecule is 100°, and an angle θ_{E4} formed by the absorption axis PA1 of the front linear polarizer 41 and the absorption axis PA2 of the back linear polarizer 42 is 55°.

### Example 6

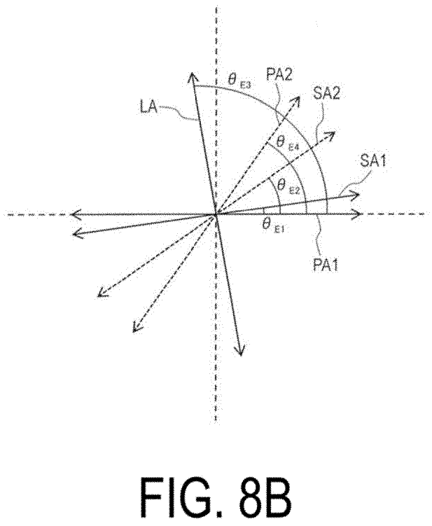

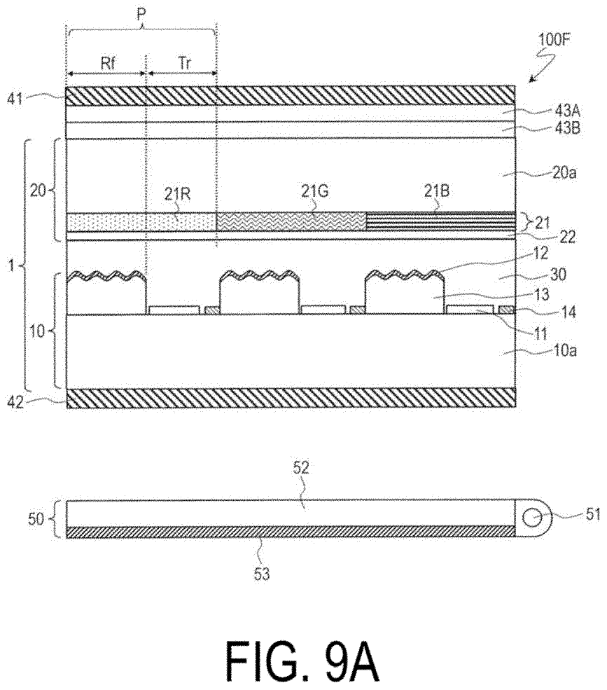

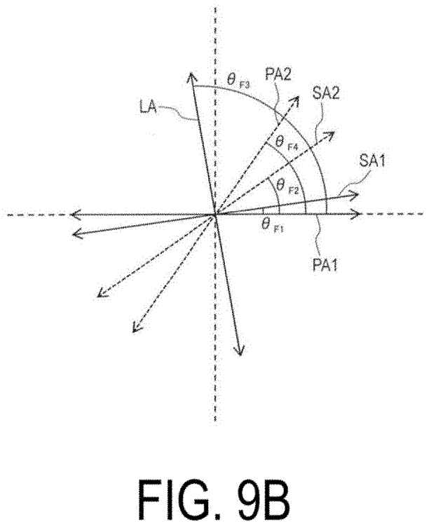

FIG. 9A illustrates a liquid crystal display device 100F according to the present example. The liquid crystal display device 100F is still another specific example of the second embodiment.

The display mode of the liquid crystal display device 100F is the VA-ECB mode. As illustrated in FIG. 9A, the liquid crystal display device 100F includes the first λ/2 plate 43A provided between the front linear polarizer 41 and the liquid crystal layer 30, and the second λ/2 plate 43B provided between the first λ/2 plate 43A and the liquid crystal layer 30. A retardation of the first λ/2 plate 43A is 270 nm. A retardation of the second λ/2 plate 43B is 250 nm. In other words, the retardation of the first λ/2 plate 43A and the retardation of the second λ/2 plate 43B are different. Retardations Δnd of the liquid crystal layer 30 are 170 nm in the reflective region Rf and 366 nm in the transmissive region Tr.

FIG. 9B is a diagram illustrating an arrangement relationship of the slow axis SA1 of the first λ/2 plate 43A, the slow axis SA2 of the second λ/2 plate 43B, the orientation direction LA of the liquid crystal molecule, and the absorption axis PA2 of the back linear polarizer 42 with reference to the absorption axis PA1 of the front linear polarizer 41. An angle θ_{F1} formed by the absorption axis PA1 of the front linear polarizer 41 and the slow axis SA1 of the first λ/2 plate 43A is 7.5°, and an angle θ_{F2} formed by the absorption axis PA1 of the front linear polarizer 41 and the slow axis SA2 of the second λ/2 plate 43B is 35°. An angle θ_{F3} formed by the absorption axis PA1 of the front linear polarizer 41 and the orientation direction LA of the liquid crystal molecule is 100°, and an angle θ_{F4} formed by the absorption axis PA1 of the front linear polarizer 41 and the absorption axis PA2 of the back linear polarizer 42 is 55°.

Example 6 is an example in which the color is adjusted to be bluish in the white display of Example 5 by reducing the retardation of the λ/2 plate (second λ/2 plate) 43B on the liquid crystal cell 1 side of the two λ/2 plates 43A and 43B from 270 nm to 250 nm.

Table 1 shows the calculation results of the reflection chromaticity at the forward viewing angle in Examples 5 and 6. The calculation was performed by a liquid crystal simulator (LCD master manufactured by SHINTEC Co., Ltd.). In the calculation, in order to confirm the degree of change in chromaticity at the time of the white display as a result of reducing the retardation of the second λ/2 plate 43B, the retardation Δnd of the liquid crystal layer 30 in the reflective region Rf of Example 6 was set to 190 nm, which is the same as that of Example 5.

TABLE 1

| | Retardation of | Reflection chromaticity at | |
|---|---|---|---|
| | second λ/2 plate | forward viewing angle | |
| | (nm) | x | y |
| Example 5 | 270 | 0.329 | 0.358 |
| Example 6 | 250 | 0.318 | 0.346 |

From Table 1, it can be seen that the reflection chromaticity of Example 6 is shifted to blue side with respect to the reflection chromaticity of Example 5.

### Example 7

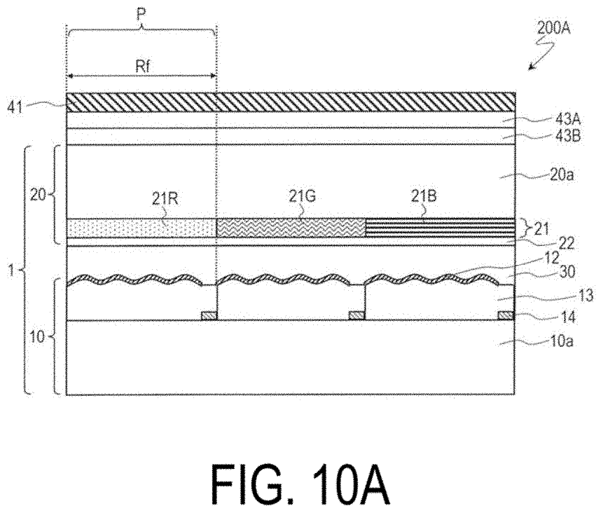

FIG. 10A illustrates a liquid crystal display device 200A according to the present example. The liquid crystal display device 200A is a specific example of the third embodiment.

The display mode of the liquid crystal display device 200A is the VA-ECB mode. As illustrated in FIG. 10A, the liquid crystal display device 200A includes a first λ/2 plate 43A provided between the front linear polarizer 41 and the liquid crystal layer 30, and a second λ/2 plate 43B provided between the first λ/2 plate 43A and the liquid crystal layer 30. A retardation of the first λ/2 plate 43A is 270 nm. A retardation of the second λ/2 plate 43B is 250 nm. A retardation Δnd of the liquid crystal layer 30 is 170 nm.

FIG. 10B is a diagram illustrating an arrangement relationship of a slow axis SA1 of the first λ/2 plate 43A, a slow axis SA2 of the second λ/2 plate 43A, and the orientation direction LA of the liquid crystal molecule with reference to the absorption axis PA1 of the front linear polarizer 41. An angle θ_{G1} formed by the absorption axis PA1 of the front linear polarizer 41 and the slow axis SA1 of the first λ/2 plate 43A is 7.5°, and an angle θ_{G2} formed by the absorption axis PA1 of the front linear polarizer 41 and the slow axis SA2 of the second λ/2 plate 43B is 35°. An angle θ_{G3} formed by the absorption axis PA1 of the front linear polarizer 41 and the orientation direction LA of the liquid crystal molecule is 100°.

### COMPARATIVE EXAMPLE

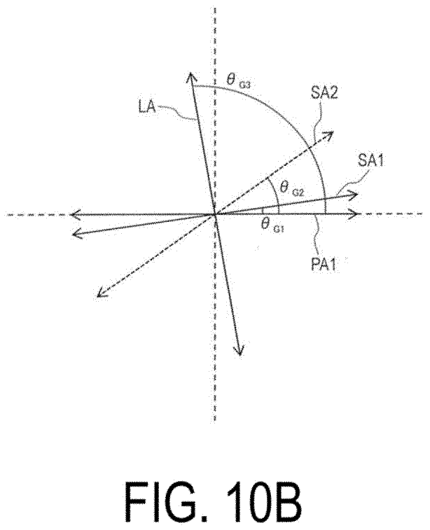

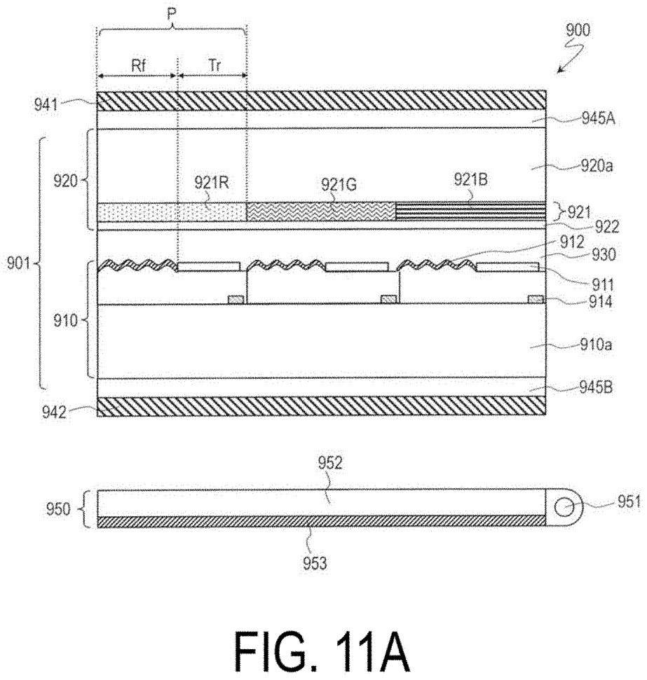

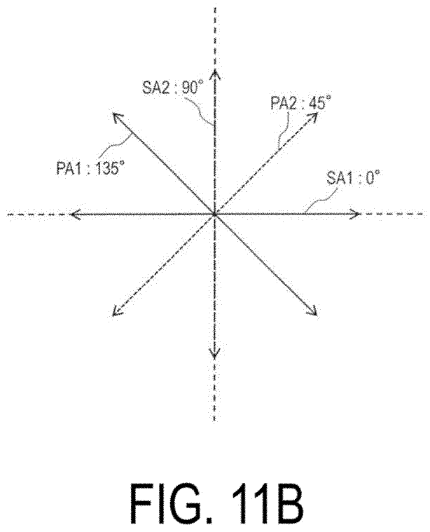

FIG. 11A illustrates a liquid crystal display device 900 according to Comparative Example. The liquid crystal display device 900 of Comparative Example includes a liquid crystal cell 901, a first linear polarizer (front linear polarizer) 941 disposed on a viewer side to the liquid crystal cell 901, a second linear polarizer (back linear polarizer) 942 disposed on a back face side to the liquid crystal cell 901, and a backlight 950 disposed on a back face side to the second linear polarizer 942. The liquid crystal display device 900 has a plurality of pixels P arranged in a matrix. Each of the plurality of pixels P includes a reflective region Rf where display is performed in a reflection mode, and a transmissive region Tr where display is performed in a transmission mode. In other words, the liquid crystal display device 900 is a transflective liquid crystal display device.

The liquid crystal cell 901 includes a TFT substrate 910, a color filter substrate 920 disposed on a viewer side to the TFT substrate 910, and a liquid crystal layer 930 provided between the TFT substrate 910 and the color filter substrate 920.

The liquid crystal display device 900 includes a first λ/4 plate 945A provided between the first linear polarizer 941 and the liquid crystal layer 930, and a second λ/4 plate 945B provided between the second linear polarizer 942 and the liquid crystal layer 930.

The TFT substrate 910 includes a transparent electrode 911 provided in the transmissive region Tr and a reflective electrode 912 provided in the reflective region Rf. A thin film transistor (not illustrated), a gate wiring line (not illustrated), a source wiring line 914, and the like are provided in a lower layer (backlight 950 side) below the reflective electrode 912 with an interlayer insulating layer interposed therebetween. The above-mentioned constituent elements of the TFT substrate 910 are supported by a transparent substrate 910a having an insulating property.

The color filter substrate 920 includes a color filter layer 921 and a counter electrode 922 provided on the color filter layer 921. The color filter layer 921 includes a red color filter 921R, a green color filter 921G, and a blue color filter 921B. The above-mentioned constituent elements of the color filter substrate 920 are supported by a transparent substrate 920a having an insulating property.

The front linear polarizer 941 and the back linear polarizer 942 are each absorbing linear polarizers. A retardation of the first λ/4 plate 945A is 140 nm. A retardation of the second λ/4 plate 945B is 140 nm.

The display mode of the liquid crystal display device 900 is a twisted VA mode. Liquid crystal molecules of the liquid crystal layer 930 form a vertical alignment in a state where no voltage is applied, and a twist alignment in a state where a voltage is applied.

FIG. 11B is a diagram illustrating an arrangement relationship of an absorption axis PA1 of the front linear polarizer 941, an absorption axis PA2 of the back linear polarizer 942, a slow axis SA1 of the first λ/4 plate 945A, and a slow axis SA2 of the second λ/4 plate 945B.

An angle formed by the absorption axis PA1 of the front linear polarizer 941 and the slow axis SA1 of the first λ/4 plate 945A is 135°, and an angle formed by the absorption axis PA2 of the back linear polarizer 942 and the slow axis SA2 of the second λ/4 plate 945B is 45°. In addition, an angle formed by the absorption axis PA1 of the front linear polarizer 941 and the absorption axis PA2 of the back linear polarizer 942 is 90°.

The front linear polarizer 941 and the first λ/4 plate 945A together function as a circular polarizer. Additionally, the back linear polarizer 942 and the second λ/4 plate 945B together function as a circular polarizer. In other words, it can be said that the liquid crystal display device 900 includes a front circular polarizer (the first linear polarizer 941 and the first λ/4 plate 945A), and a back circular polarizer (the second linear polarizer 942 and the second λ/4 plate 945B).

### Suitable Range for Retardation of Liquid Crystal Layer

For each of the examples, the result of verifying a suitable range for the retardation Δnd of the liquid crystal layer 30 will be described. For verification, a liquid crystal simulator (LCD master manufactured by SHINTEC Co., Ltd.) was used to calculate the reflection contrast and the reflectivity when the retardation Δnd of the liquid crystal layer 30 was varied. The reflection contrast referred to here is an average reflection contrast in a viewing angle range of an azimuth angle from 0° to 360° and a polar angle from 0° to 60°, and the reflectivity referred to here is an average reflectivity in a viewing angle range of an azimuth angle from 0° to 360° and a polar angle from 0° to 60°.

By obtaining the ratio of the reflection contrast of each of the examples to the reflection contrast of Comparative Example (reflection contrast ratio) and the ratio of the reflectivity of each of the examples to the reflectivity of Comparative Example (reflectivity ratio), the range of the retardation Δnd having higher reflection contrast and reflectivity than those of Comparative Example was verified for each of the examples.

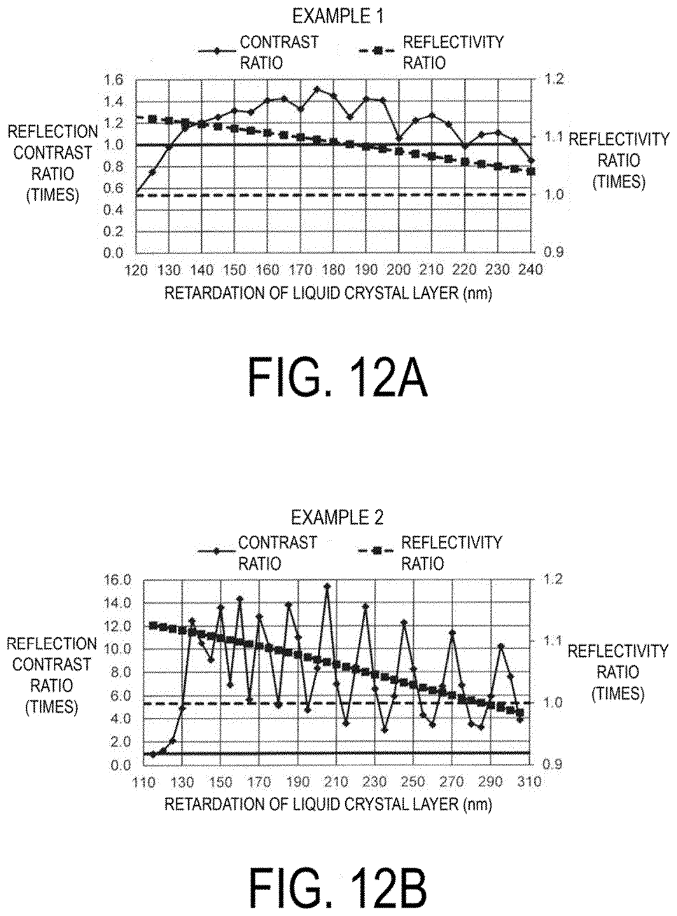

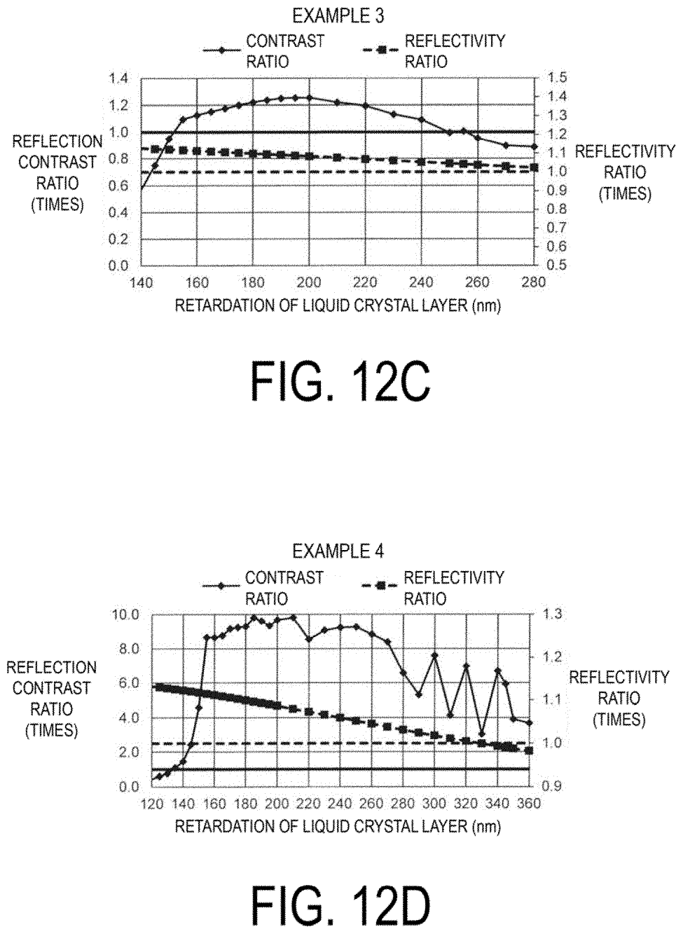

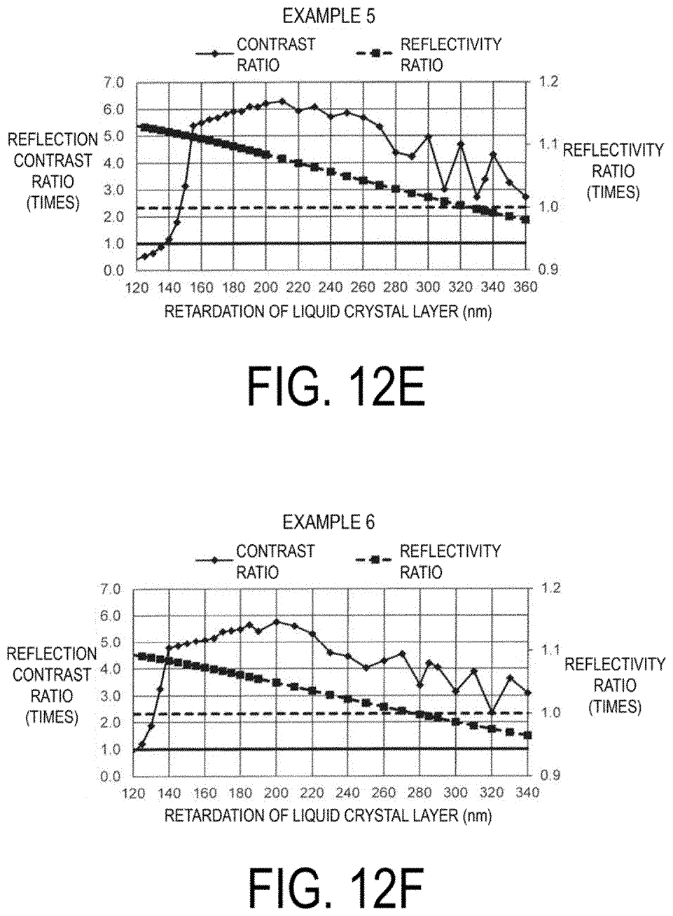

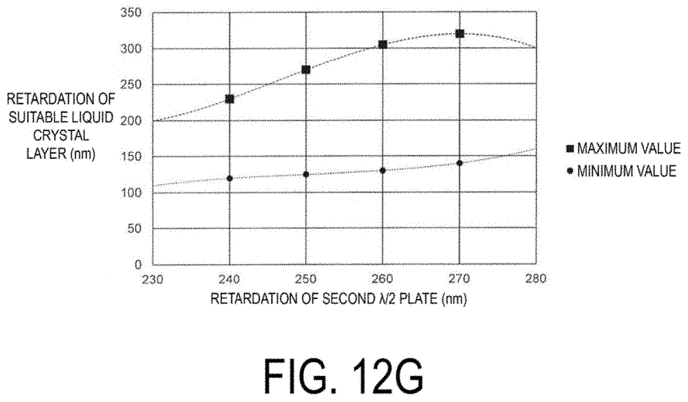

FIG. 12A shows relationships between the retardation Δnd of the liquid crystal layer 30 in the reflective region Rf and the reflection contrast ratio and the reflectivity ratio for Example 1.

From FIG. 12A, it can be seen that in Example 1, in a range from 135 nm to 215 nm, the reflection contrast ratio is higher than that in Comparative Example, and in a range from 120 nm to 240 nm, the reflectivity ratio is higher than that in Comparative Example. Therefore, in Example 1, the retardation Δnd of the liquid crystal layer 30 in the reflective region Rf is preferably from 135 nm to 215 nm.

FIG. 12B shows relationships between the retardation Δnd of the liquid crystal layer 30 in the reflective region Rf and the reflection contrast ratio and the reflectivity ratio for Example 2.

From FIG. 12B, it can be seen that in Example 2, in a range from 120 nm to 280 nm, the reflection contrast ratio is higher than that in Comparative Example, and in a range from 110 nm to 240 nm, the reflectivity ratio is higher than that in Comparative Example. Therefore, in Example 2, the retardation Δnd of the liquid crystal layer 30 in the reflective region Rf is preferably from 120 nm to 240 nm.

FIG. 12C shows relationships between the retardation Δnd of the liquid crystal layer 30 in the reflective region Rf and the reflection contrast ratio and the reflectivity ratio for Example 3.

From FIG. 12C, it can be seen that in Example 3, in a range from 155 nm to 255 nm, the reflection contrast ratio is higher than that in Comparative Example, and in a range from 140 nm to 280 nm, the reflectivity ratio is higher than that in Comparative Example. Therefore, in Example 3, the retardation Δnd of the liquid crystal layer 30 in the reflective region Rf is preferably from 155 nm to 255 nm.

FIG. 12D shows relationships between the retardation Δnd of the liquid crystal layer 30 in the reflective region Rf and the reflection contrast ratio and the reflectivity ratio for Example 4.

From FIG. 12D, it can be seen that in Example 4, in a range from 135 nm to 360 nm, the reflection contrast ratio is higher than that in Comparative Example, and in a range from 120 nm to 320 nm, the reflectivity ratio is higher than that in Comparative Example. Therefore, in Example 4, the retardation Δnd of the liquid crystal layer 30 in the reflective region Rf is preferably from 135 nm to 320 nm.

FIG. 12E shows relationships between the retardation Δnd of the liquid crystal layer 30 in the reflective region Rf and the reflection contrast ratio and the reflectivity ratio for Example 5.

From FIG. 12E, it can be seen that in Example 5, in a range from 140 nm to 360 nm, the reflection contrast ratio is higher than that in Comparative Example, and in a range from 120 nm to 320 nm, the reflectivity ratio is higher than that in Comparative Example. Therefore, in Example 5, the retardation Δnd of the liquid crystal layer 30 in the reflective region Rf is preferably from 140 nm to 320 nm.

FIG. 12F shows relationships between the retardation Δnd of the liquid crystal layer 30 in the reflective region Rf and the reflection contrast ratio and the reflectivity ratio for Example 6.

From FIG. 12F, it can be seen that in Example 6, in a range from 125 nm to 340 nm, the reflection contrast ratio is higher than that in Comparative Example, and in a range from 120 nm to 270 nm, the reflectivity ratio is higher than that in Comparative Example. Therefore, in Example 6, the retardation Δnd of the liquid crystal layer 30 in the reflective region Rf is preferably from 125 nm to 270 nm.

For Example 6, when the retardations of the second λ/2 plate 43B were 240 nm and 260 nm, suitable ranges of the retardations Δnd of the liquid crystal layer 30 in the reflective region Rf (ranges in which the reflection contrast ratio and the reflectivity ratio were higher than those in Comparative Example) were calculated. The results are listed in Table 2. Table 2 also shows the suitable ranges when the retardation of the second λ/2 plate 43B is 250 nm (FIG. 12F), and when it is 270 nm (FIG. 12E).

TABLE 2

| | Suitable range for retardation of liquid | |
|---|---|---|
| Retardation of second | crystal layer in reflective region | |
| λ/2 plate (nm) | Minimum value (nm) | Maximum value (nm) |
| 240 | 120 | 230 |
| 250 | 125 | 270 |
| 260 | 130 | 305 |
| 270 | 140 | 320 |

Summarizing the results shown in Table 2, it was found that there was a relationship as shown in a graph in FIG. 12G between the retardation of the second λ/2 plate 43B and the suitable range of the retardation Δnd of the liquid crystal layer 30 in the reflective region Rf. When the retardation of the second λ/2 plate 43B is a [nm], and the retardation Δnd of the liquid crystal layer 30 in the reflective region Rf is b [nm], from the graph of FIG. 12G, an equation (approximate equation) of b=0.000833333333333303a³−0.624999999999975a²+156.66666666666a−12999.9999999994 was obtained for the minimum value of b. Also, an equation (approximate equation) of b=−0.00249999999999991a³+1.84999999999993a²−452.24999999998a+36769.9999999981 was obtained for the maximum value of b. Therefore, it is preferable to satisfy an inequality of 0.000833333333333303a³−0.624999999999975a²+156.66666666666a−12999.9999999994≤b≤−0.00249999999999991a³+1.84999999999993a²−452.24999999998a+36769.9999999981.

Note that the above findings (the suitable range for the retardation Δnd of the liquid crystal layer 30 in the reflective region Rf) may also be applied to the liquid crystal display device 200 of the “third embodiment” (that is, of the reflective type). For example, when the display mode of the liquid crystal display device 200 is the ECB mode and the liquid crystal display device 200 does not include a λ/2 plate between the linear polarizer 41 and the liquid crystal layer 30, the findings obtained for Example 1 (the retardation Δnd of the liquid crystal layer 30 in the reflective region Rf is preferably from 135 nm to 215 nm) can be applied. The findings obtained for other examples can be applied as well.

### Suitable Axis Setting

For each of the examples, the results of verifying a suitable axis setting will be described. For verification, the relationship between the axis angle and the polarization state after passing through the liquid crystal layer 30 when the reflection black display is displayed (the in-plane retardation of the liquid crystal layer 30 in the reflective region Rf was approximately λ/4) was confirmed using a liquid crystal simulator (LCD master manufactured by SHINTEC Co., Ltd.). The polarization state was confirmed with the Stokes parameter S3 of light with a wavelength of 550 nm. The Stokes parameter S3 varies in a range −1≤S3≤1. The closer the absolute value is to 1, the more ideal the circularly-polarized light is, and the better the black display is, so that the reflection contrast becomes higher. The positive and negative signs indicate the difference in the direction of rotation of circularly-polarized light, where the negative sign indicates left handed circularly-polarized light and the positive sign indicates right handed circularly-polarized light.

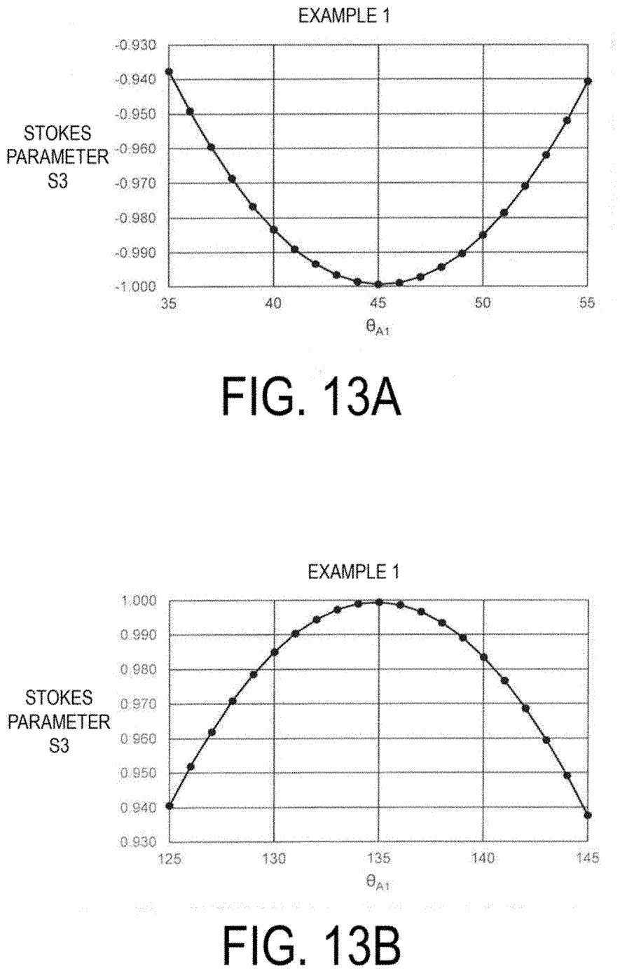

FIGS. 13A and 13B illustrate a relationship between the angle θ_{A1} formed by the absorption axis PA1 of the front linear polarizer 41 and the orientation direction LA of the liquid crystal molecule and the Stokes parameter S3 for Example 1. FIGS. 13A and 13B are graphs in which the horizontal axis represents θ_{A1} and the vertical axis represents the Stokes parameter S3.

From FIGS. 13A and 13B, it can be seen that the absolute value |S3| of the Stokes parameter S3 is 0.999 or greater in a range of 44°≤θ_{A1}≤46° and 134°≤θ_{A1}≤136°. Therefore, it is preferable that the relationship of 44°≤θ_{A1}≤46° or 134°≤θ_{A1}≤136° be satisfied.

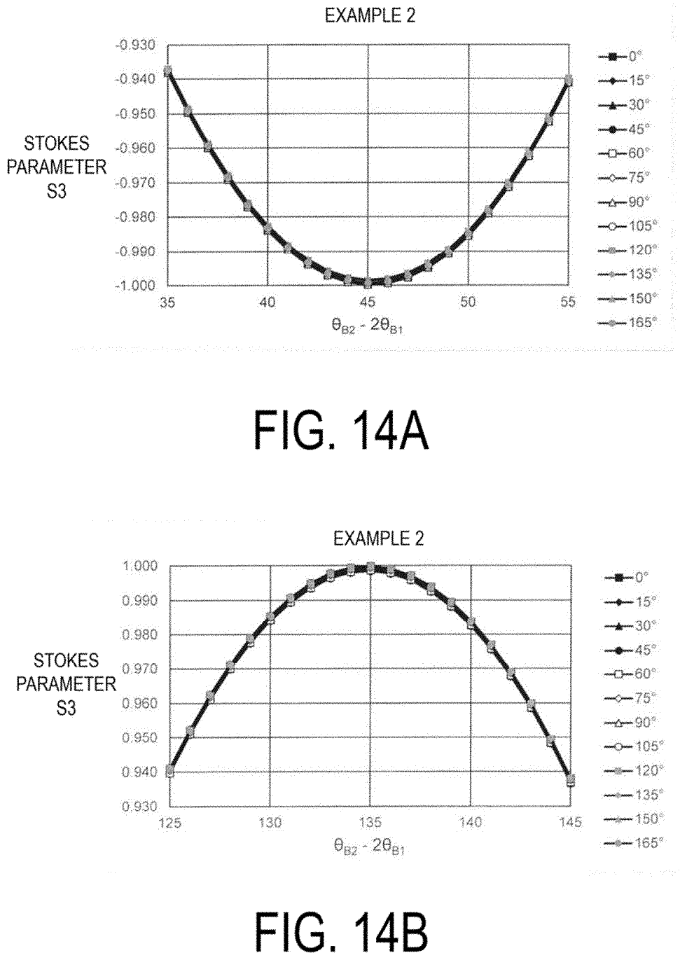

FIGS. 14A and 14B illustrate a relationship between the angle θ_{B1} formed by the absorption axis PA1 of the front linear polarizer 41 and the slow axis SA1 of the λ/2 plate 43, the angle θ_{B2} formed by the absorption axis PA1 of the front linear polarizer 41 and the orientation direction LA of the liquid crystal molecule, and the Stokes parameter S3 for Example 2. FIGS. 14A and 14B are graphs in which the horizontal axis represents θ_{B2}−2θ_{B1} and the vertical axis represents the Stokes parameter S3. Each legend in the graphs illustrates the magnitude of θ_{B1}.

From FIGS. 14A and 14B, it can be seen that the absolute value |S3| of the Stokes parameter S3 is 0.999 or greater in ranges of 44°≤θ_{B2}−2θ_{B1}≤46° and 134°≤θ_{B2}−2θ_{B1}≤136°. Therefore, it is preferable that the relationship of 44°≤θ_{B2}−2θ_{B1}≤46° or 134°≤θ_{B2}−2θ_{B1}≤136° be satisfied.

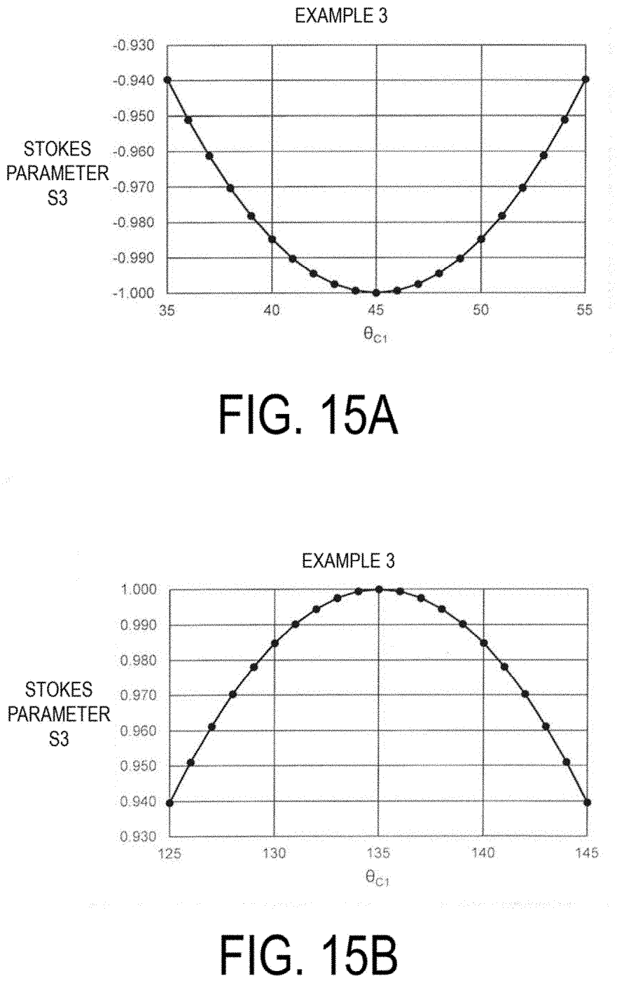

FIGS. 15A and 15B illustrate a relationship between the angle θ_{C1} formed by the absorption axis PA1 of the front linear polarizer 41 and the orientation direction LA of the liquid crystal molecule and the Stokes parameter S3 for Example 3. FIGS. 15A and 15B are graphs in which the horizontal axis represents θ_{C1} and the vertical axis represents the Stokes parameter S3.

From FIGS. 15A and 15B, it can be seen that the absolute value |S3| of the Stokes parameter S3 is 0.999 or greater in a range of 44°≤θ_{C1}≤46° and 134°≤θ_{C1}≤136°. Therefore, it is preferable that the relationship of 44°≤θ_{c1}≤46° or 134°≤θ_{C1}≤136° be satisfied.

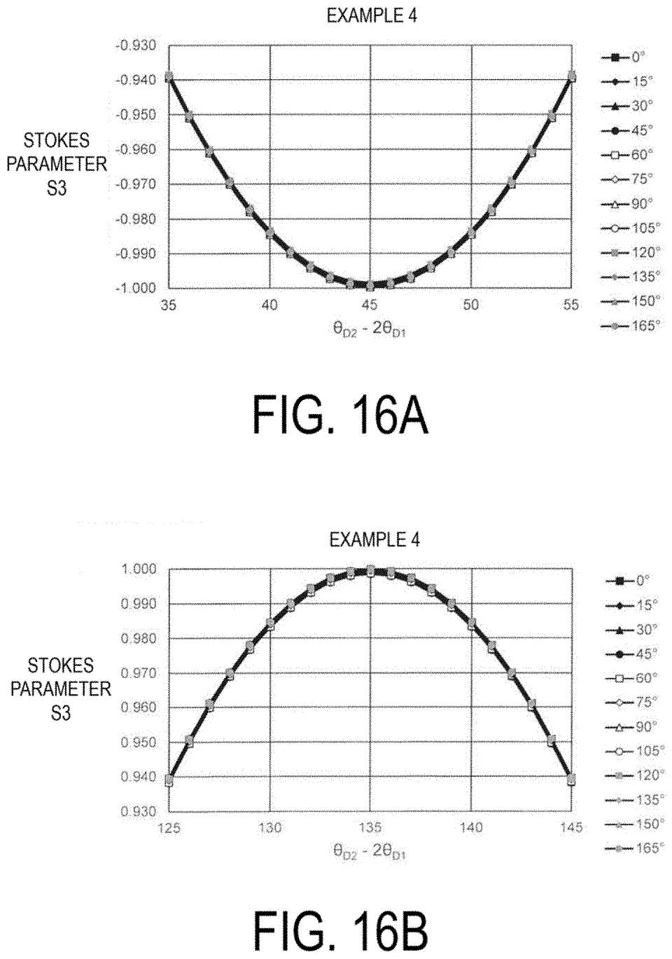

FIGS. 16A and 16B illustrate a relationship between the angle θ_{D1} formed by the absorption axis PA1 of the front linear polarizer 41 and the slow axis SA1 of the λ/2 plate 43, the angle θ_{D2} formed by the absorption axis PA1 of the front linear polarizer 41 and the orientation direction LA of the liquid crystal molecule, and the Stokes parameter S3 for Example 4. FIGS. 16A and 16B are graphs in which the horizontal axis represents θ_{D2}−2θ_{D1} and the vertical axis represents the Stokes parameter S3. Each legend in the graphs illustrates the magnitude of θ_{D1}.

From FIGS. 16A and 16B, it can be seen that the absolute value |S3| of the Stokes parameter S3 is 0.999 or greater in ranges of 44°≤θ_{D2}−2θ_{D1}≤46° and 134°≤θ_{D2}−2θ_{D1}≤136°. Therefore, it is preferable that the relationship of 44°≤θ_{D2}−2θ_{D1}≤46° or 134°≤θ_{D2}−2θ_{D1}≤136° be satisfied.

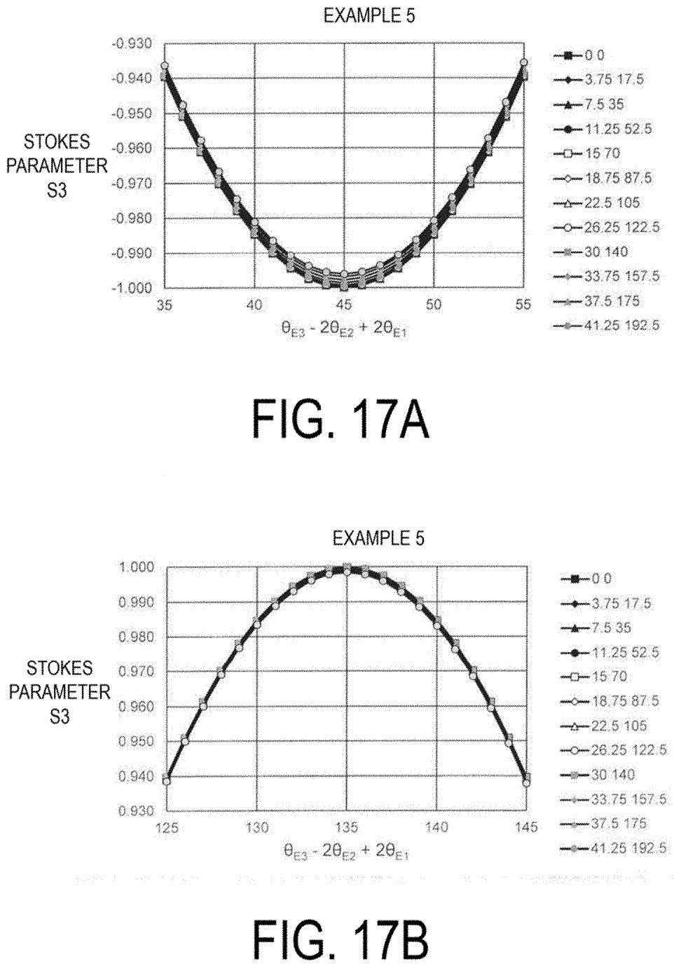

FIGS. 17A and 17B illustrate a relationship between the angle θ_{E1} formed by the absorption axis PA1 of the front linear polarizer 41 and the slow axis SA1 of the first λ/2 plate 43A, the angle θ_{E2} formed by the absorption axis PA1 of the front linear polarizer 41 and the slow axis SA2 of the second λ/2 plate 43B, the angle θ_{E3} formed by the absorption axis PA1 of the front linear polarizer 41 and the orientation direction LA of the liquid crystal molecule, and the Stokes parameter S3 for Example 5. FIGS. 17A and 17B are graphs in which the horizontal axis represents θ_{E3}−2θ_{E2}+2θ_{E1} and the vertical axis represents the Stokes parameter S3. Each legend in the graphs illustrates the magnitude of θ_{E1} (left) and θ_{E2} (right).

From FIGS. 17A and 17B, it can be seen that the absolute value |S3| of the Stokes parameter S3 is approximately 0.999 or greater in a range of 44°≤θ_{E3}−2θ_{E2}+2θ_{E1}≤46° and 134°≤θ_{E3}−2θ_{E2}+2θ_{E1}≤136°. Therefore, it is preferable that the relationship of 44°≤θ_{E3}−2θ_{E2}+2θ_{E1}≤46° or 134°≤θ_{E3}−2θ_{E2}+2θ_{E1}≤136° be satisfied.

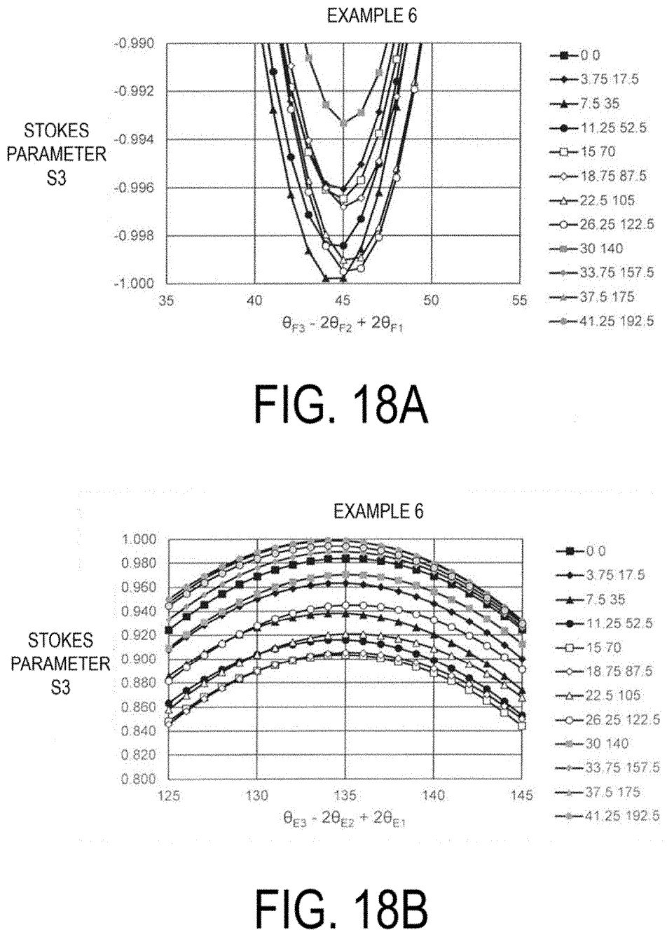

FIGS. 18A and 18B illustrate a relationship between the angle θ_{F1} formed by the absorption axis PA1 of the front linear polarizer 41 and the slow axis SA1 of the first λ/2 plate 43A, the angle θ_{F2} formed by the absorption axis PA1 of the front linear polarizer 41 and the slow axis SA2 of the second λ/2 plate 43B, the angle θ_{F3} formed by the absorption axis PA1 of the front linear polarizer 41 and the orientation direction LA of the liquid crystal molecule, and the Stokes parameter S3 for Example 6. FIGS. 18A and 18B are graphs in which the horizontal axis represents θ_{F3}−2θ_{F2}+2θ_{F1} and the vertical axis represents the Stokes parameter S3. Each legend in the graphs illustrates the magnitude of θ_{F1} (left) and θ_{F2} (right).

From FIGS. 18A and 18B, it can be seen that the absolute value |S3| of the Stokes parameter S3 has the maximum value in a range of 44°≤θ_{F3}−2θ_{F2}+2θ_{F1}≤46° and 134°≤θ_{F3}−2θ_{F2}+2θ_{F1}≤136°, although the maximum value varies slightly depending on the combination of θ_{F1} and θ_{F2}. Therefore, it is preferable that the relationship of 44°≤θ_{F3}−2θ_{F2}+2θ_{F1}≤46° or 134°≤θ_{F3}−2θ_{F2}+2θ_{F1}≤136° be satisfied.

Note that the above findings (suitable axis setting) may also be applied to the liquid crystal display device 200 of the “third embodiment” (that is, of the reflective type). For example, when the display mode of the liquid crystal display device 200 is the ECB mode and the liquid crystal display device 200 does not include a λ/2 plate between the linear polarizer 41 and the liquid crystal layer 30, the findings obtained for Example 1 (the angle θ_{A1} formed by the absorption axis PA1 of the front linear polarizer 41 and the orientation direction LA of the liquid crystal molecule preferably satisfies the relationship 44°≤θ_{A1}≤46° or 134°≤θ_{A1}≤136° can be applied. The findings obtained for other examples can be applied as well.

### Suitable Retardation Ratio

For each of the examples, the result of verifying a suitable range of the ratio for the retardation Δnd of the liquid crystal layer 30 in the transmissive region Tr to the retardation Δnd of the liquid crystal layer 30 in the reflective region Rf (hereinafter also referred to as “liquid crystal layer retardation ratio”) will be described. For verification, a liquid crystal simulator (LCD master manufactured by SHINTEC Co., Ltd.) was used to calculate a change in transmission contrast in accordance with the retardation Δnd of the liquid crystal layer 30 in the transmissive region Tr, and a range of the retardation ratio at which the transmission contrast was the highest was set as a suitable range.

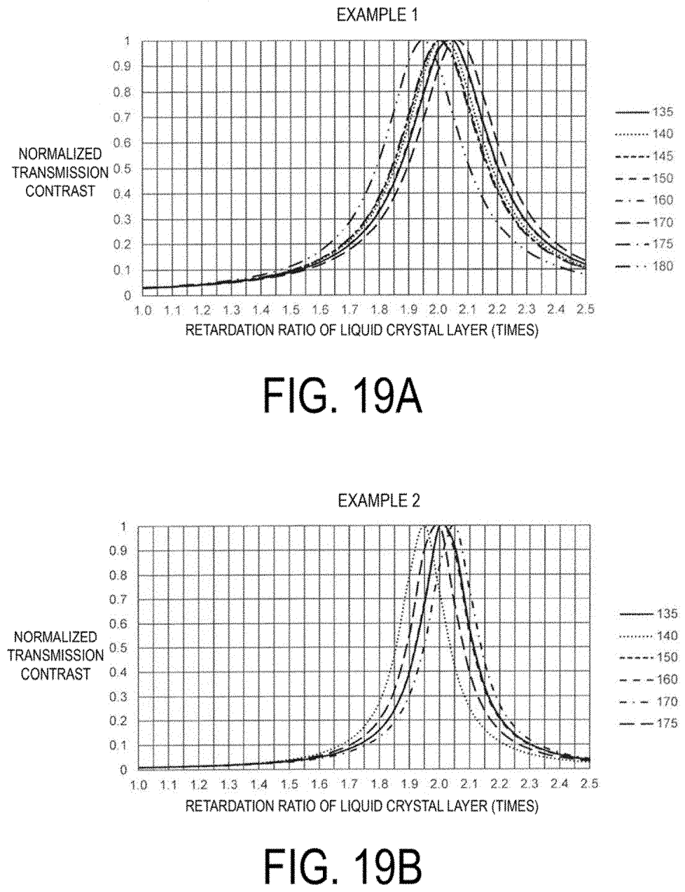

FIGS. 19A and 19B illustrate relationships between the liquid crystal layer retardation ratio and the normalized transmission contrast for Examples 1 and 2. From FIGS. 19A and 19B, it can be seen that the transmission contrasts are the highest when the liquid crystal layer retardation ratio is from 1.95 to 2.05 for Examples 1 and 2, respectively. Therefore, in Examples 1 and 2, the liquid crystal layer retardation ratio is preferably from 1.95 to 2.05.

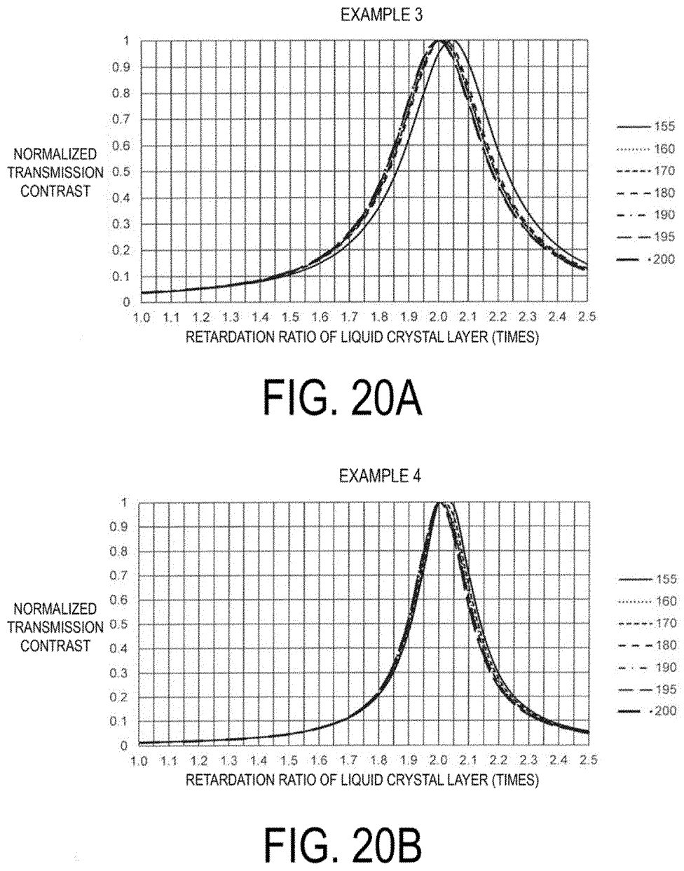

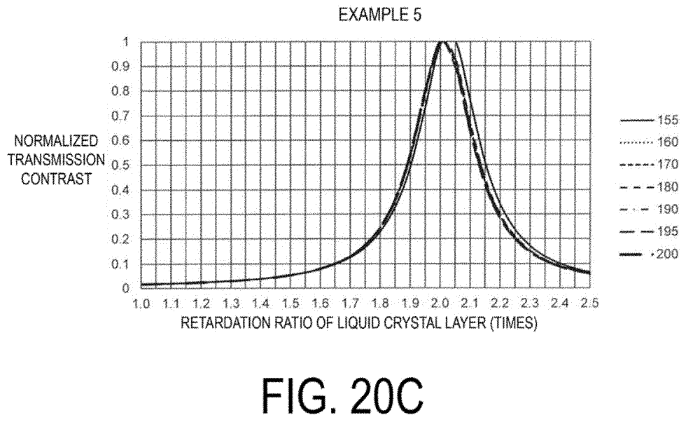

FIGS. 20A, 20B, and 20C illustrate relationships between the liquid crystal layer retardation ratio and the normalized transmission contrast for Examples 3, 4, and 5. From FIGS. 20A, 20B, and 20C, it can be seen that the transmission contrasts are the highest when the liquid crystal layer retardation ratio is from 2.00 to 2.05 for Examples 3, 4, and 5, respectively. Therefore, in Examples 3, 4, and 5, the liquid crystal layer retardation ratio is preferably from 2.00 to 2.05.

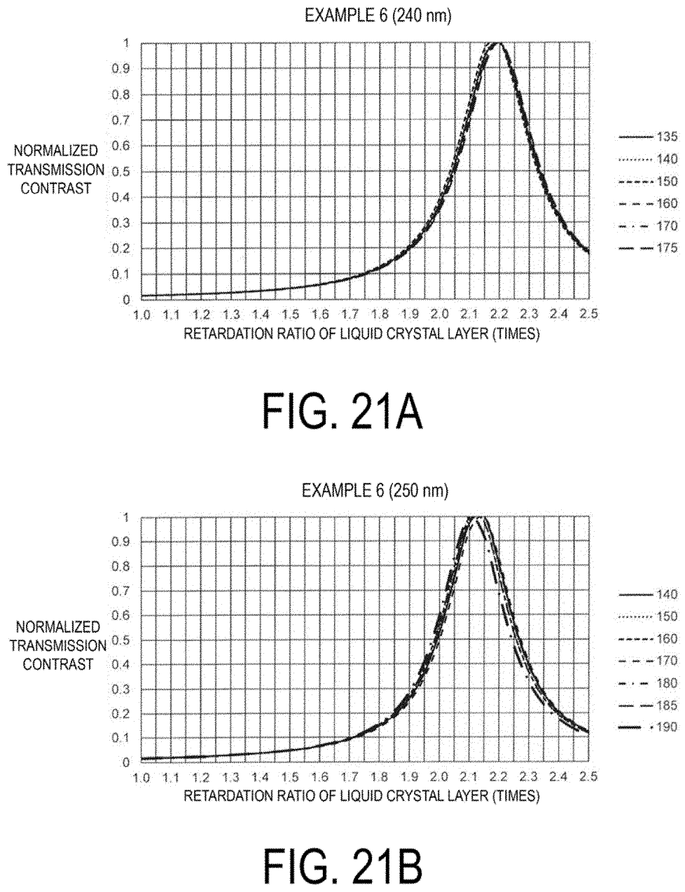

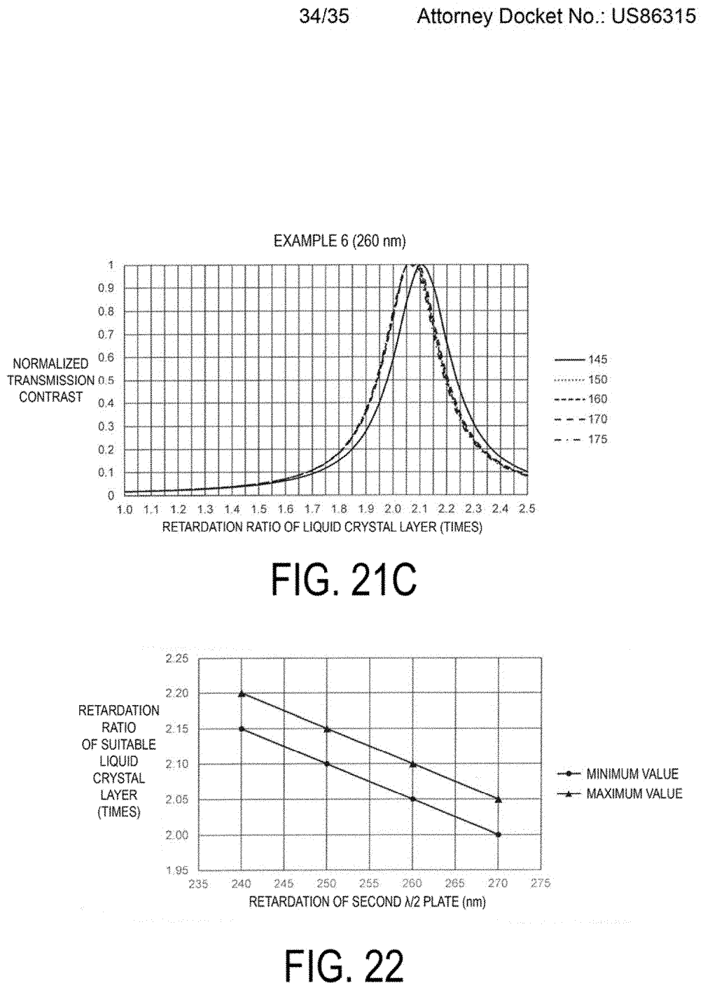

FIGS. 21A, 21B, and 21C illustrate relationships between the liquid crystal layer retardation ratio and the normalized transmission contrast when the retardation of the second λ/2 plate 43B is 240 nm, 250 nm, and 260 nm for Example 6.

From FIG. 21A, it can be seen that when the retardation of the second λ/2 plate 43B is 240 nm, the transmission contrast is the highest when the liquid crystal layer retardation ratio is from 2.15 to 2.2. In addition, from FIG. 21B, it can be seen that when the retardation of the second λ/2 plate 43B is 250 nm, the transmission contrast is the highest when the liquid crystal layer retardation ratio is from 2.10 to 2.15. Further, from FIG. 21C, it can be seen that when the retardation of the second λ/2 plate 43B is 260 nm, the transmission contrast is the highest when the liquid crystal layer retardation ratio is from 2.05 to 2.10. Furthermore, from FIG. 20C, which depicts Example 5, it can be seen that when the retardation of the second λ/2 plate 43B is 270 nm, the transmission contrast is the highest when the retardation ratio is from 2.00 to 2.05.

Summarizing the above results, it was found that there was a relationship as shown in a graph in FIG. 22 between the retardation of the second λ/2 plate 43B and the suitable liquid crystal layer retardation ratio. When the retardation of the second λ/2 plate 43B was x [nm] and the liquid crystal layer retardation ratio was y, from the graph of FIG. 22, equations of y=−0.005x+3.350 for the minimum value of y and y=−0.005x+3.400 for the maximum value of y were obtained. Therefore, it is preferable that an inequality of −0.005x+3.350≤y≤−0.005x+3.400 be satisfied.

### Voltage-Reflectivity Characteristics at Forward Viewing Angle

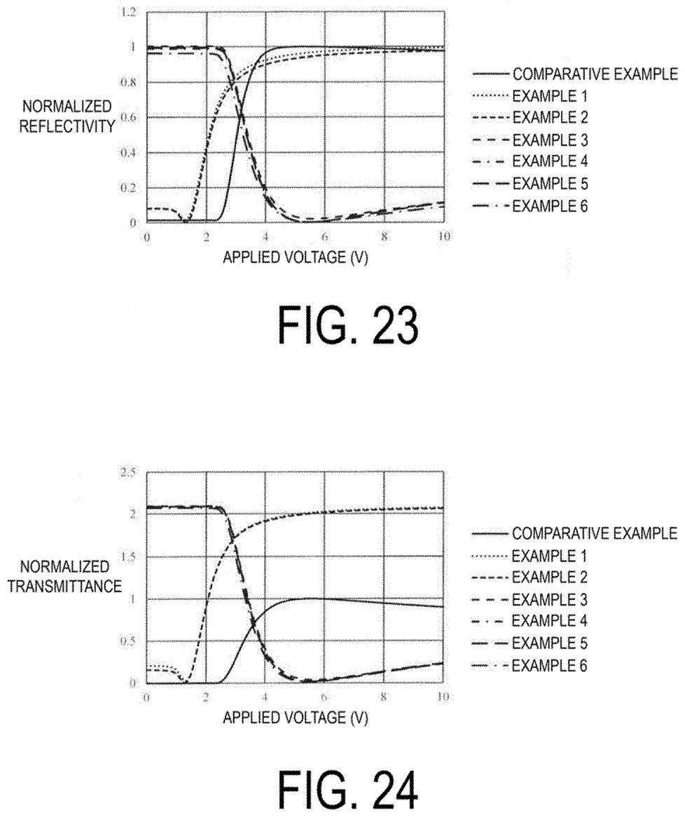

For the respective examples and Comparative Example, the voltage-reflectivity characteristics (VR curves) at the forward viewing angle were compared. FIG. 23 illustrates relationships between the voltage applied to the liquid crystal layer 30 and the normalized reflectivity (reflectivity normalized using the maximum reflectivity of Comparative Example) for Examples 1 to 6 and Comparative Example.

From FIG. 23, it can be seen that in each of Examples 1 to 6, the reflectivity equivalent to that in Comparative Example was obtained.

### Voltage-Transmittance Characteristics at Forward Viewing Angle

For the respective examples and Comparative Example, the voltage-transmittance characteristics (VT curves) at the forward viewing angle were compared. FIG. 24 illustrates relationships between the voltage applied to the liquid crystal layer 30 and the normalized transmittance (transmittance normalized using the maximum transmittance of Comparative Example) for Examples 1 to 6 and Comparative Example.

From FIG. 24, it can be seen that in each of Example 1 to 6, the transmittance is approximately twice with reference to Comparative Example.

### Comparison of Transmission Brightness and Light Recycling Effects

The transmission brightness was measured for each of the examples and Comparative Example using a spectrophotometer SR-UL1 manufactured by TOPCON CORPORATION. For the measurement, the back linear polarizer was set under the following four conditions (conditions (1) to (4)). The transmission aperture ratios of the respective examples and Comparative Example are the same.

(1) Absorbing polarizer alone

(2) Absorbing polarizer and DBEF (disposed on the backlight side to the absorbing polarizer)

(3) High transmission absorbing polarizer and DBEF (disposed on the backlight side to the high transmission absorbing polarizer)

(4) DBEF alone

Table 3 shows the measurement results of the transmission brightness.

TABLE 3

| | Transmission brightness (cd/m²) | | | |
|---|---|---|---|---|
| | | Absorbing | High transmission | |
| | Absorbing | polarizer | absorbing polarizer | |
| | polarizer | and DBEF | and DBEF | DBEF |
| Comparative | 16.9 | 21.9 | — | — |
| Example | | | | |
| Example 1 | 41.4 | 58.4 | — | — |
| Example 2 | 41.3 | 58.5 | — | — |
| Example 3 | 42.1 | 59.7 | — | — |
| Example 4 | 41.3 | 59.2 | — | — |
| Example 5 | 41.4 | 59.4 | — | — |
| Example 6 | 41.8 | 59.9 | 64.0 | 69.0 |

From Table 3, it can be seen that the transmission brightness of each of Examples 1 to 6 was higher than that of Comparative Example. Further, it can be seen that the transmission brightness of each of the conditions (2), (3), and (4) is higher than that of the condition (1).

Table 4 shows the normalized transmission brightness (transmission brightness ratio) of each of the other conditions, using the transmission brightness of the condition (1) shown in Table 3 as a reference.

TABLE 4

| | Transmission brightness ratio (times) | | | |
|---|---|---|---|---|
| | | Absorbing | High transmission | |
| | Absorbing | polarizer | absorbing polarizer | |
| | polarizer | and DBEF | and DBEF | DBEF |
| Comparative | 1.00 | 1.30 | — | — |
| Example | | | | |
| Example 1 | 1.00 | 1.41 | — | — |
| Example 2 | 1.00 | 1.42 | — | — |
| Example 3 | 1.00 | 1.42 | — | — |
| Example 4 | 1.00 | 1.43 | — | — |
| Example 5 | 1.00 | 1.43 | — | — |
| Example 6 | 1.00 | 1.43 | 1.53 | 1.65 |

As shown in Table 4, in Comparative Example, the transmission brightness ratio of the condition (2) was 1.30 times, whereas in Examples 1 to 6, the transmission brightness ratios of condition (2) were 1.41 to 1.43 times. Therefore, it can be seen that the light recycling effects were improved (1.08 to 1.10 times better than Comparative Example). In this manner, it was confirmed that the light recycling effect was improved by changing the back polarizer from the circular polarizer to the linear polarizer.

### Comparison of Reflectivity

For each of the examples and Comparative Example, reflectivity was calculated using a liquid crystal simulator (LCD master manufactured by SHINTEC Co., Ltd.). The reflectivity referred to here is an average reflectivity in a viewing angle range of an azimuth angle 0° to 360° and a polar angle 0° to 60°. The calculation results are shown in Table 5. In Table 5, in addition to the reflectivity, the reflectivity normalized by using the reflectivity of Comparative Example as a reference (i.e., reflectivity ratio) is also shown.

TABLE 5

| | | Retardation of | | |
|---|---|---|---|---|
| | | liquid crystal | | |
| | Display | layer in reflective | Reflectivity | Reflectivity |
| | mode | region (nm) | (%) | ratio |
| Comparative | Twisted VA | — | 32.48 | 1.000 |
| Example | | | | |
| Example 1 | ECB | 160 | 35.98 | 1.108 |
| Example 2 | ECB | 160 | 35.59 | 1.096 |
| Example 3 | VA-ECB | 190 | 35.30 | 1.087 |
| Example 4 | VA-ECB | 190 | 35.45 | 1.091 |
| Example 5 | VA-ECB | 190 | 35.36 | 1.089 |
| Example 6 | VA-ECB | 170 | 34.55 | 1.064 |

From Table 5, it can be seen that the reflectivity of each of Example 1 to 6 was higher than that of Comparative Example. Further, from these results, it is readily understood that the reflective liquid crystal display devices 200 and 200A of Example 7 (third embodiment) will have higher reflectivity than a known reflective liquid crystal display device provided with a circular polarizer.

According to the embodiments of the disclosure, the liquid crystal display device in which each pixel includes a reflective region can increase the usage efficiency of light without increasing the manufacturing cost.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1. A liquid crystal display device having a plurality of pixels arranged in a matrix, each of which includes a reflective region where display is performed in a reflection mode, the liquid crystal display device comprising:
a liquid crystal cell including a first substrate, a second substrate disposed on a viewer side to the first substrate, and a liquid crystal layer provided between the first substrate and the second substrate; and
a first linear polarizer disposed on a viewer side to the liquid crystal cell,
wherein no λ/4 plate is provided between the first linear polarizer and the liquid crystal layer, and
an in-plane retardation of the liquid crystal layer in the reflective region is configured to change from approximately zero to approximately λ/4 depending on a voltage applied to the liquid crystal layer.

2. The liquid crystal display device according to claim 1,
wherein the liquid crystal display device performs display in an ECB mode.

3. The liquid crystal display device according to claim 2,
wherein no λ/2 plate is provided between the first linear polarizer and the liquid crystal layer.

4. The liquid crystal display device according to claim 3,
wherein a retardation Δnd of the liquid crystal layer in the reflective region is from 135 nm to 215 nm.

5. The liquid crystal display device according to claim 3,
wherein an inequality of 44°≤θ_{A1}≤46° or 134°≤θ_{A1}≤136° is satisfied, where θ_{A1} is an angle formed by an absorption axis of the first linear polarizer and an orientation direction of a liquid crystal molecule of the liquid crystal layer.

6. The liquid crystal display device according to claim 2, further comprising:
a λ/2 plate provided between the first linear polarizer and the liquid crystal layer.

7. The liquid crystal display device according to claim 6,
wherein a retardation Δnd of the liquid crystal layer in the reflective region is from 120 nm to 240 nm.

8. The liquid crystal display device according to claim 6,
wherein an inequality of 44°≤θ_{B2}−2θ_{B1}≤46° or 134°≤θ_{B2}−2θ_{B1}≤136° is satisfied, where θ_{B1} is an angle formed by an absorption axis of the first linear polarizer and a slow axis of the λ/2 plate, and θ_{B2} is an angle formed by the absorption axis of the first linear polarizer and an orientation direction of a liquid crystal molecule of the liquid crystal layer.

9. The liquid crystal display device according to claim 2, further comprising:
a second linear polarizer disposed on a back face side to the liquid crystal cell,
wherein each of the plurality of pixels further includes a transmissive region where display is performed in a transmission mode,
the liquid crystal display device does not include a λ/4 plate between the second linear polarizer and the liquid crystal layer,
an in-plane retardation of the liquid crystal layer in the transmissive region is configured to vary from approximately zero to approximately λ/2 depending on a voltage applied to the liquid crystal layer, and
a ratio of a retardation Δnd of the liquid crystal layer in the transmissive region to a retardation Δnd of the liquid crystal layer in the reflective region is from 1.95 to 2.05.

10. The liquid crystal display device according to claim 1,
wherein the liquid crystal display device performs display in a VA mode.

11. The liquid crystal display device according to claim 10,
wherein no λ/2 plate is provided between the first linear polarizer and the liquid crystal layer.

12. The liquid crystal display device according to claim 11,
wherein a retardation Δnd of the liquid crystal layer in the reflective region is from 155 nm to 255 nm.

13. The liquid crystal display device according to claim 11,
wherein an inequality of 44°≤θ_{C1}≤46° or 134°≤θ_{C1}≤136° is satisfied, where θ_{C1} is an angle formed by an absorption axis of the first linear polarizer and an orientation direction of a liquid crystal molecule of the liquid crystal layer.

14. The liquid crystal display device according to claim 10, further comprising:
a λ/2 plate provided between the first linear polarizer and the liquid crystal layer.

15. The liquid crystal display device according to claim 14,
wherein a retardation Δnd of the liquid crystal layer in the reflective region is from 135 nm to 320 nm.

16. The liquid crystal display device according to claim 14,
wherein an inequality of 44°≤θ_{D2}−2θ_{D1}≤46° or 134°≤θ_{D2}−2θ_{D1}≤136° is satisfied, where θ_{D1} is an angle formed by an absorption axis of the first linear polarizer and a slow axis of the λ/2 plate and θ_{D2} is an angle formed by the absorption axis of the first linear polarizer and an orientation direction of a liquid crystal molecule of the liquid crystal layer.

17. The liquid crystal display device according to claim 10, further comprising:
a first λ/2 plate provided between the first linear polarizer and the liquid crystal layer; and
a second λ/2 plate provided between the first λ/2 plate and the liquid crystal layer.

18. The liquid crystal display device according to claim 17,
wherein a retardation Δnd of the liquid crystal layer in the reflective region is from 140 nm to 320 nm.

19. The liquid crystal display device according to claim 17,
wherein an inequality of 44°≤θ_{E3}−2θ_{E2}+2θ_{E1}≤46° or 134°≤θ_{E3}−2θ_{E2}+2θ_{E1}≤136° is satisfied, where θ_{E1} is an angle formed by an absorption axis of the first linear polarizer and a slow axis of the first λ/2 plate, θ_{E2} is an angle formed by the absorption axis of the first linear polarizer and a slow axis of the second λ/2 plate, and θ_{E3} is an angle formed by the absorption axis of the first linear polarizer and an orientation direction of a liquid crystal molecule of the liquid crystal layer.

20. The liquid crystal display device according to claim 10, further comprising:
a second linear polarizer disposed on a back face side to the liquid crystal cell,
wherein each of the plurality of pixels further includes a transmissive region where display is performed in a transmission mode,
the liquid crystal display device does not include a λ/4 plate between the second linear polarizer and the liquid crystal layer,
an in-plane retardation of the liquid crystal layer in the transmissive region is configured to vary from approximately zero to approximately λ/2 depending on a voltage applied to the liquid crystal layer, and
a ratio of a retardation Δnd of the liquid crystal layer in the transmissive region to a retardation Δnd of the liquid crystal layer in the reflective region is from 2.00 to 2.05.

21. The liquid crystal display device according to claim 10, further comprising:
a first λ/2 plate provided between the first linear polarizer and the liquid crystal layer; and
a second λ/2 plate provided between the first λ/2 plate and the liquid crystal layer,
wherein a retardation of the first λ/2 plate is approximately 270 nm, and
a retardation of the second λ/2 plate is approximately 250 nm.

22. The liquid crystal display device according to claim 21,
wherein a retardation Δnd of the liquid crystal layer in the reflective region is from 125 nm to 270 nm.

23. The liquid crystal display device according to claim 21,
wherein an inequality of 44°≤θ_{F3}−2θ_{F2}+2θ_{F1}≤46° or 134°≤θ_{F3}−2θ_{F2}+2θ_{F1}≤136° is satisfied, where θ_{F1} is an angle formed by an absorption axis of the first linear polarizer and a slow axis of the first λ/2 plate, and θ_{F2} is an angle formed by the absorption axis of the first linear polarizer and a slow axis of the second λ/2 plate, and θ_{F3} is an angle formed by the absorption axis of the first linear polarizer and an orientation direction of a liquid crystal molecule of the liquid crystal layer.

24. The liquid crystal display device according to claim 10, further comprising:
a first λ/2 plate provided between the first linear polarizer and the liquid crystal layer; and
a second λ/2 plate provided between the first λ/2 plate and the liquid crystal layer,
wherein a retardation of the first λ/2 plate is approximately 270 nm, and
an inequality of 0.000833333333333303a³−0.624999999999975a²+156.66666666666a−12999.9999999994≤b≤−0.00249999999999991a³+1.84999999999993a²−452.24999999998a+36769.9999999981 is satisfied, where a retardation of the second λ/2 plate is a [nm], and a retardation Δnd of the liquid crystal layer in the reflective region is b [nm].

25. The liquid crystal display device according to claim 10, further comprising:
a first λ/2 plate provided between the first linear polarizer and the liquid crystal layer;
a second λ/2 plate provided between the first λ/2 plate and the liquid crystal layer; and
a second linear polarizer disposed on a back face side to the liquid crystal cell,
wherein each of the plurality of pixels further includes a transmissive region where display is performed in a transmission mode,
the liquid crystal display device does not include a λ/4 plate between the second linear polarizer and the liquid crystal layer,
an in-plane retardation of the liquid crystal layer in the transmissive region is configured to vary from approximately zero to approximately λ/2 depending on a voltage applied to the liquid crystal layer,
a retardation of the first λ/2 plate is approximately 270 nm, and
an inequality of −0.005x+3.350≤y≤−0.005x+3.400 is satisfied, where x [nm] is a retardation of the second λ/2, and y is a ratio of a retardation Δnd of the liquid crystal layer in the transmissive region to a retardation Δnd of the liquid crystal layer in the reflective region.

26. The liquid crystal display device according to claim 1,
wherein, in a case in which the in-plane retardation of the liquid crystal layer in the reflective region is approximately λ/4, in a case in which polarized light with a Stokes parameter S3 having an absolute value |S3| of 0 is incident on the liquid crystal layer in the reflective region, |S3| of the polarized light passing through the liquid crystal layer in the reflective region is 0.999 or greater.

27. The liquid crystal display device according to claim 1, further comprising:
a second linear polarizer disposed on a back face side to the liquid crystal cell,
wherein each of the plurality of pixels further includes a transmissive region where display is performed in a transmission mode,
the liquid crystal display device does not include a λ/4 plate between the second linear polarizer and the liquid crystal layer, and
an in-plane retardation of the liquid crystal layer in the transmissive region is configured to vary from approximately zero to approximately λ/2 depending on a voltage applied to the liquid crystal layer.
